(19) United States
(12) Patent Application Publication
(10) Pub. No.: US 2005/0005039 A1
(43) Pub. Date: Jan. 6, 2005

(54) Data transfer control device, electronic instrument, and data transfer control method

(75) Inventor: Nobuyuki Saito, Sapporo-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/847,585

(22) Filed: May 18, 2004

(30) Foreign Application Priority Data
May 20, 2003 (JP) 2003-142195

(51) Int. Cl. G06F 13/14

(52) U.S. Cl. 710/52

(57) ABSTRACT

A data transfer control device includes a buffer controller which allocates a plurality of pipe regions in a packet buffer and controls access to the packet buffer. The buffer controller includes an address translation table which stores a plurality of pipe region numbers each of which is assigned to one of a plurality of divided blocks in a memory region of the packet buffer and generates a physical access address of the packet buffer based on the stored pipe region numbers, one of the pipe region numbers to which access is requested, and a relative access address of the pipe regions, and a region allocator which performs reconstruction processing of the pipe regions (deletion, addition, or change in size of the pipe regions) by changing the pipe region numbers assigned to the divided blocks.

Japanese Patent Application No. 2003-142195, filed on May 20, 2003, is hereby incorporated by reference in its entirety.

### BACKGROUND OF THE INVENTION

The present invention relates to a data transfer control device, an electronic instrument, and a data transfer control method.

The Universal Serial Bus (USB) 2.0 standard has been developed and has attracted attention as a standard which can realize a data transfer rate of 480 Mbps (HS mode), which is remarkably higher than the data transfer rate in the USB 1.1 standard, while maintaining compatibility with the USB 1.1 standard. Japanese Patent Application Laid-open No. 2002-135132 discloses a conventional art of a USB data transfer control device, for example.

The market for the USB 2.0 standard which supports the high speed (HS) mode has grown steadily. The USB On-The-Go (OTG) standard has been developed by the USB Implementers Forum (USB-IF) as a standard which realizes a USB simple host. The OTG standard (OTG 1.0) developed as an extension of the USB 2.0 standard has the potential for creating a new added value for the USB interface, and development of applications making use of its characteristics has been anticipated.

A peripheral (peripheral device) which has been connected with a host (personal computer or the like) through the USB can be provided with a host function by utilizing a simple host realized by the OTG standard or the like. This enables data to be transferred between peripherals by connecting the peripherals through the USB. For example, an image from a digital camera can be printed by directly connecting the digital camera with a printer, or data can be saved by connecting a digital camera or a digital video camera with a storage device.

However, a low performance CPU (processing section in a broad sense) is generally provided in a peripheral which is provided with the host function by utilizing the OTG simple host or the like. Therefore, if the processing load of the CPU (firmware) included in the peripheral is increased or the processing becomes complicated by the addition of the host function, other processing is hindered or the design period of the instrument is increased.

### BRIEF SUMMARY OF THE INVENTION

According to one aspect of the present invention, there is provided a data transfer control device which includes a buffer controller which allocates a plurality of pipe regions in a packet buffer and controls access to the packet buffer, each of the pipe regions storing data transferred to or from corresponding one of endpoints, and a transfer controller which controls data transfer between each of the pipe regions and corresponding one of the endpoints, the data transfer control device comprising:
an address translation table which stores pipe region numbers each of which is assigned to at least one of divided blocks, the divided blocks being obtained by dividing a memory region of the packet buffer, and generates a physical access address of the packet buffer based on the stored pipe region numbers, a pipe region number to which access is requested, and a relative access address of the pipe regions; and
a region allocator which performs reconstruction processing of the pipe regions by changing the pipe region number assigned to the divided block of the packet buffer, the reconstruction processing including at least one of processing of deleting the allocated pipe region, processing of adding a new pipe region, and processing of changing a size of the pipe region.

According to another aspect of the present invention, there is provided a data transfer control device which includes a buffer controller which allocates a plurality of pipe regions in a packet buffer and controls access to the packet buffer, each of the pipe regions storing data transferred to or from corresponding one of endpoints, and a transfer controller which controls data transfer between each of the pipe regions and corresponding one of the endpoints, the data transfer control device comprising:
an address translation table which translates a logical access address of the packet buffer into a physical access address of the packet buffer; and
a region allocator which performs reconstruction processing of the pipe regions by changing correspondence between the logical access address and the physical access address in the address translation table, the reconstruction processing including at least one of processing of deleting the allocated pipe region, processing of adding a new pipe region, and processing of changing a size of the pipe region;
wherein the region allocator changes the correspondence between the logical access address and the physical access address for a first pipe region allocated in the packet buffer before and after the reconstruction processing corresponding to a first endpoint so that the physical access address does not change even when the logical access address of the first pipe region changes.

### BRIEF DESCRIPTION OF THE SEVERAL VIEWS OF THE DRAWING

FIGS. 1A, 1B, and 1C are illustrative of the USB OTG standard.

FIG. 2 is a configuration example of a data transfer control device according to an embodiment of the present invention.

FIGS. 3A and 3B are illustrative of a pipe region and an endpoint region.

FIGS. 4A and 4B are illustrative of reconstruction of a pipe region.

FIGS. 5A and 5B are illustrative of a reconstruction method according to an embodiment of the present invention.

FIG. 6 is illustrative of a reconstruction method according to an embodiment of the present invention.

FIG. 7 is a flowchart illustrating an operation during reconstruction processing.

FIG. 8 is a timing waveform diagram illustrating an operation during the reconstruction processing.

FIG. 9 is a detailed configuration example of a buffer controller.

FIGS. 10A, 10B, and 10C are illustrative of a region allocation method and a pointer assignment method.

FIG. 11 is a detailed configuration example of an address translation table.

FIG. 12 is an operation explanatory diagram of an address translation table.

FIG. 13 is a detailed configuration example of a table calculator.

FIGS. 14A, 14B, and 14C are operation explanatory diagrams of a table calculator.

FIG. 15 is an operation explanatory diagram of a table calculator.

FIG. 16 is illustrative of operation of a data transfer control device during a host operation.

FIG. 17 is illustrative of operation of a data transfer control device during a peripheral operation.

FIG. 18 is illustrative of a register section.

FIG. 19 is a flowchart illustrating firmware processing.

FIG. 20 is a signal waveform example of automatic IN transaction processing.

FIG. 21 is a signal waveform example of automatic OUT transaction processing.

FIG. 22 is a configuration example of an electronic instrument.

### DETAILED DESCRIPTION OF THE EMBODIMENT

Embodiments of the present application are described below. Note that the embodiments described below do not limit the scope of the invention defined by the claims laid out herein. Similarly, the overall configuration of the embodiments below should not be taken as limiting the subject matter defined by the claims herein.

1. Simple Host

1.1 Device-A and Device-B

The USB On-The-Go (OTG) standard is briefly described below as an example of a standard which realizes a simple host. However, the method of the present invention is not limited to the data transfer control method of the OTG standard.

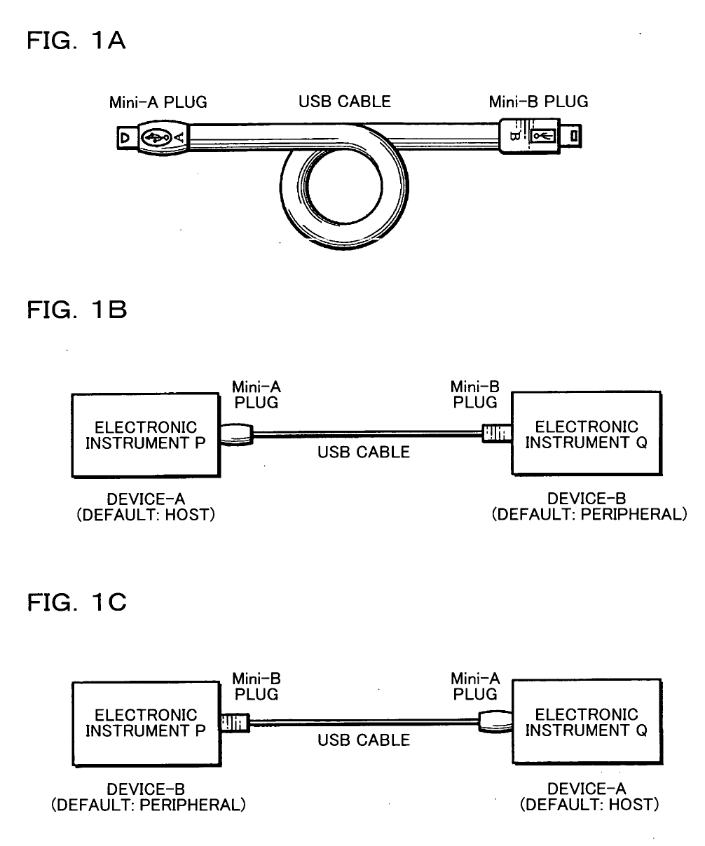

In the OTG standard, a Mini-A plug and a Mini-B plug as shown in FIG. 1A are defined as the connector standard. A Mini-AB receptacle is also defined as a connector to which both the Mini-A plug and the Mini-B plug (first and second plugs of a cable in a broad sense) can be connected.

As shown in FIG. 1B, when an electronic instrument P is connected with the Mini-A plug of the USB cable and an electronic instrument Q is connected with the Mini-B plug of the USB cable, the electronic instrument P becomes a device-A and the electronic instrument Q becomes a device-B. When the Mini-B plug and the Mini-A plug are respectively connected to the electronic instruments P and Q as shown in FIG. 1C, the electronic instrument P and the electronic instrument Q respectively become a device-B and a device-A. The electronic instrument determines whether the electronic instrument is connected with either type of plug by detecting a voltage level of an ID pin by using a built-in pull-up resistor circuit.

In the OTG standard, the device-A (master) provides a power supply (VBUS) (supplier), and the device-B (slave) receives a power supply (receiver). The device-A becomes a host in a default state, and the device-B becomes a peripheral (peripheral device) in a default state.

1.2 Dual-role Device

A dual-role device capable of having the role of a host (simple host) and the role of a peripheral is defined in the OTG standard.

The dual-role device can become either a host or a peripheral. In the case where a partner connected with the dual-role device is a host or a peripheral in the conventional USB standard, the role of the dual-role device is determined uniquely. In other words, if the connection partner is a host, the dual-role device becomes a peripheral. If the connection partner is a peripheral, the dual-role device becomes a host. If the connection partner is a dual-role device, the dual-role devices can exchange the role of a host and the role of a peripheral.

The dual-role device has a function of Session Request Protocol (SRP) and a function of Host Negotiation Protocol (HNP). SRP is a protocol for the device-B to request the device-A to supply power to VBUS. HNP is a protocol for exchanging the role of a host and the role of a peripheral.

As described above, when the dual-role devices are connected, the device-A to which the Mini-A plug is connected becomes a default host, and the device-B to which the Mini-B plug is connected becomes a default peripheral. In the OTG standard, the role of a host and the role of a peripheral can be exchanged without plugging and unplugging. HNP is a protocol for realizing the role exchange.

2. OHCI

In the conventional USB standard, a host controller provided in a personal computer as a host conforms to a standard such as Open Host Controller Interface (OHCI) proposed by Microsoft Corporation or Universal Host Controller Interface (UHCI). An operating system (OS) to be used is limited to the OS produced by Microsoft Corporation or Apple Computer, Inc.

However, in a small portable instrument which is the OTG target application, the architecture of the CPU to be incorporated or the OS to be used is multifarious. Moreover, OHCI and UHCI, which are standardized for a host controller of a personal computer, are developed on the assumption that the entire USB host functions are provided. Therefore, OHCI and UHCI are not optimum for a small portable instrument. In a data transfer control device (host controller) conforming to OHCI, since firmware (host controller driver) which operates on the CPU must create descriptors having a complicated list structure, the processing load of the CPU is increased.

The performance of the CPU embedded in a small portable instrument (digital camera, portable telephone, or the like) is generally lower than the performance of the CPU provided in a personal computer. Therefore, if the portable instrument is allowed to perform the OTG host operation, an excessive load is applied to the CPU embedded in the portable instrument, whereby other processing is hindered or the data transfer performance is decreased.

3. Configuration Example

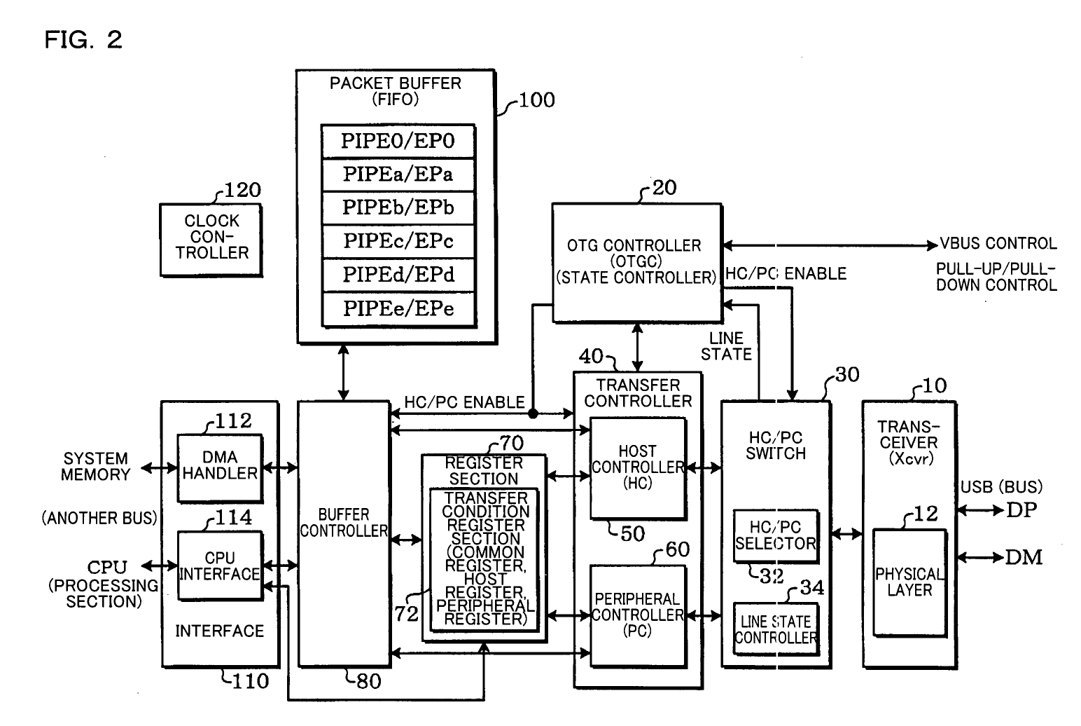

FIG. 2 shows a configuration example of a data transfer control device (data transfer control circuit) in the present embodiment which can solve the above-described problems. The data transfer control device in the present embodiment may have a configuration in which some of the functional blocks shown in FIG. 2 are omitted. The functional blocks shown in FIG. 2 may be realized by using only hardware circuits, or may be realized by using hardware circuits and firmware (software). An example in which the present invention is applied to a data transfer control device conforming to the OTG standard is described below. However, the present invention may be applied to a data transfer control device conforming to a standard developed from the OTG standard, or a data transfer control device which does not conform to the OTG standard. For example, the present invention may be applied to a data transfer control device which does not have a dual-role device function and has only a simple host function.

The data transfer control device includes a transceiver 10 (hereafter may be called “Xcvr”). The transceiver 10 is a circuit which transmits and receives data through the USB (bus in a broad sense) by using differential data signals DP and DM, and includes a USB physical layer (PHY) circuit 12. In more detail, the transceiver 10 generates the DP/DM line state (J, K, SE0, or the like), and performs serial/parallel conversion, parallel/serial conversion, bit stuffing, bit unstuffing, NRZI decoding, NRZI encoding, and the like. The transceiver 10 may be provided outside the data transfer control device.

The data transfer control device includes an OTG controller 20 (state controller in a broad sense; hereinafter may be called “OTGC”). The OTG controller 20 performs processing of realizing the SRP function and the HNP function in the OTG standard. Specifically, the OTG controller 20 controls a plurality of states including a state of a host operation which operates in the role of a host, a state of a peripheral operation which operates in the role of a peripheral, and the like.

In more detail, the OTG standard defines state transition of the dual-role device when operating as the device-A and state transition of the dual-role device when operating as the device-B. The OTG controller 20 includes a state machine for realizing the state transition. The OTG controller 20 includes a circuit which detects (monitors) the USB data line state, the VBUS level, and the ID pin state. The state machine included in the OTG controller 20 changes the state (state such as host, peripheral, suspend, or idle) based on the detected information. The state transition may be realized by using a hardware circuit, or realized by allowing firmware to set a state command in a register. When the state transition occurs, the OTG controller 20 controls VBUS or controls connection/disconnection of pull-up resistors/pull-down resistors of the data signal lines DP and DM based on the state after transition. The OTG controller 20 controls enabling/disabling of a host controller 50 (hereinafter may be called “HC”) and a peripheral controller 60 (hereinafter may be called “PC”).

The data transfer control device includes an HC/PC switch circuit 30 (HC/PC common circuit). The HC/PC switch circuit 30 controls connection switching between the transceiver 10 and the host controller 50 or the peripheral controller 60. The HC/PC switch circuit 30 instructs the transceiver 10 to generate the USB data (DP, DM) line state. The connection switching control is realized by an HC/PC selector 32. The instructions for line state generation are realized by a line state controller 34.

For example, when the OTG controller 20 asserts an HC enable signal during the host operation, the HC/PC switch circuit 30 (HC/PC selector 32) connects the transceiver 10 with the host controller 50. When the OTG controller 20 asserts a PC enable signal during the peripheral operation, the HC/PC switch circuit 30 connects the transceiver 10 with the peripheral controller 60. This enables the host controller 50 and the peripheral controller 60 to be operated exclusively.

The data transfer control device includes a transfer controller 40. The transfer controller 40 is a circuit which controls data transfer through the USB (bus in a broad sense), and includes the host controller 50 (HC) and the peripheral controller 60 (PC). In the case of realizing only the simple host function, the peripheral controller 60 may not be included in the transfer controller 40.

The host controller 50 is a circuit which controls data transfer in the role of a host during the host operation (when the HC enable signal is asserted). Specifically, the host controller 50 is connected with the transceiver 10 by the HC/PC switch circuit 30 during the host operation. The host controller 50 automatically generates a transaction to an endpoint based on transfer condition information set in a transfer condition register section 72 in a register section 70. The host controller 50 automatically transfers data (packet) (data transfer by a hardware circuit in which the processing section does not take part) between a pipe region (PIPE0 to PIPEe; hereinafter may be called “PIPE”) allocated in a packet buffer 100 and an endpoint corresponding to the pipe region.

In more detail, the host controller 50 arbitrates between pipe transfers, and performs time management in a frame, transfer scheduling, resend management, and the like. The host controller 50 manages the transfer condition information (operation information) of pipe transfer through the register section 70. The host controller 50 manages transactions, assembles/disassembles a packet, and instructs to generate a suspend/resume/reset state.

The peripheral controller 60 is a circuit which controls data transfer in the role of a peripheral during the peripheral operation (when the PC enable signal is asserted).

Specifically, the peripheral controller 60 is connected with the transceiver 10 by the HC/PC switch circuit 30 during the peripheral operation. The peripheral controller 60 transfers data between the endpoint region (EP0 to EPe; hereinafter may be called “EP”) allocated in the packet buffer 100 and a host based on the transfer condition information set in the transfer condition register section 72 in the register section 70.

In more detail, the peripheral controller 60 manages the transfer condition information (operation information) of endpoint transfer through the register section 70. The peripheral controller 60 manages transactions, assembles/disassembles a packet, and instructs to generate a remote wakeup signal.

The endpoint is a point (portion) on a peripheral (device) to which a unique address can be assigned. Data transfer between a host and a peripheral (device) is performed through the endpoint. A transaction is made up of a token packet, an optional data packet, and an optional handshake packet.

The data transfer control device includes the register section 70. The register section 70 includes various registers for performing data transfer (pipe transfer or endpoint transfer) control, buffer access control, buffer management, interrupt control, block control, or DMA control. The registers may be realized by a memory such as a RAM, or realized by D flip-flops or the like. The registers in the register section 70 may not be positioned together, and may be dispersed in each block (HC, PC, OTGC, Xcvr, and the like).

The register section 70 includes the transfer condition register section 72. The transfer condition register section 72 includes registers which store the transfer condition information on data transfer between the pipe region (PIPE0 to PIPEe) allocated in the packet buffer 100 during the host operation and the endpoint. The transfer condition register is provided corresponding to each pipe region in the packet buffer 100.

The endpoint region (EP0 to EPe) is allocated in the packet buffer 100 during the peripheral operation. Data is transferred between the data transfer control device and the host based on the transfer condition information set in the transfer condition register section 72.

The data transfer control device includes a buffer controller 80 (FIFO manager). The buffer controller 80 performs processing of allocating the pipe region or the endpoint region in the packet buffer 100. The buffer controller 80 performs access control and region management of the packet buffer 100. In more detail, the buffer controller 80 controls access from the CPU (access from the processing section), access from the DMA (access from an application layer device), and access from the USB (access from the transfer controller), arbitrates between these accesses, and generates and manages the access address.

The data transfer control device includes the packet buffer 100 (FIFO, packet memory, or data buffer). The packet buffer 100 temporarily stores (buffers) data transferred through the USB (transmission data or reception data). The packet buffer 100 may be formed by a random access memory (RAM), for example. A part or the entirety of the packet buffer 100 may be provided outside the data transfer control device (may be an external memory).

The packet buffer 100 is used as a First-In First-Out (FIFO) for pipe transfer during the host operation. Specifically, the pipe regions PIPE0 to PIPEe (buffer regions in a broad sense) are allocated in the packet buffer 100 corresponding to each endpoint on the USB (bus). Data (transmission data or reception data) transferred between the pipe region and the corresponding endpoint is stored in the pipe regions PIPE0 to PIPEe.

The packet buffer 100 is used as a FIFO for endpoint transfer during the peripheral operation. Specifically, the endpoint regions EP0 to EPe (buffer regions in a broad sense) are allocated in the packet buffer 100 during the peripheral operation. Data (transmission data or reception data) transferred between the endpoint regions EP0 to EPe and the host is stored in the endpoint regions EP0 to EPe.

The buffer region (region which is assigned to the pipe region during the host operation and is assigned to the endpoint region during the peripheral operation) allocated in the packet buffer 100 is assigned to a storage region in which information input first is output first (FIFO region). The pipe region PIPE0 is a pipe region dedicated to the endpoint 0 for control transfer. The pipe regions PIPEa to PIPEe are general-purpose pipe regions which can be assigned to arbitrary endpoints. In the USB standard, the endpoint 0 is assigned to an endpoint dedicated to control transfer. Therefore, confusion by the user can be prevented by assigning the pipe region PIPE0 to the pipe region dedicated to control transfer as in the present embodiment. Moreover, the pipe region corresponding to the endpoint can be dynamically changed by assigning the pipe regions PIPEa to PIPEe to the pipe regions which can be assigned to arbitrary endpoints. This increases the degrees of freedom relating to pipe transfer scheduling, whereby efficiency of data transfer can be increased.

In the present embodiment, a region size RSize of the buffer region is set by a maximum packet size MaxPktSize (page size in a broad sense) and a number of pages BufferPage (RSize=MaxPktSize×BufferPage). This enables the region size and the number of layers (number of pages) of the buffer region to be arbitrarily set, whereby resources of the packet buffer 100 can be efficiently utilized.

The data transfer control device includes an interface circuit 110. The interface circuit 110 is a circuit for performing data transfer between a direct memory access (DMA) bus or a CPU bus, which is another bus differing from the USB, and the packet buffer 100. The interface circuit 110 includes a DMA handler circuit 112 (first interface circuit in a broad sense) for performing DMA transfer between the packet buffer 100 and an external system memory. The interface circuit 110 also includes a CPU interface circuit 114 (second interface circuit in a broad sense) for performing parallel I/O (PIO) transfer between the packet buffer 100 and the external CPU. The CPU (processing section in a broad sense) may be provided in the data transfer control device.

The data transfer control device includes a clock controller 120. The clock controller 120 generates various clock signals used in the data transfer control device based on a built-in PLL or a clock signal input from the outside.

4. Pipe Region

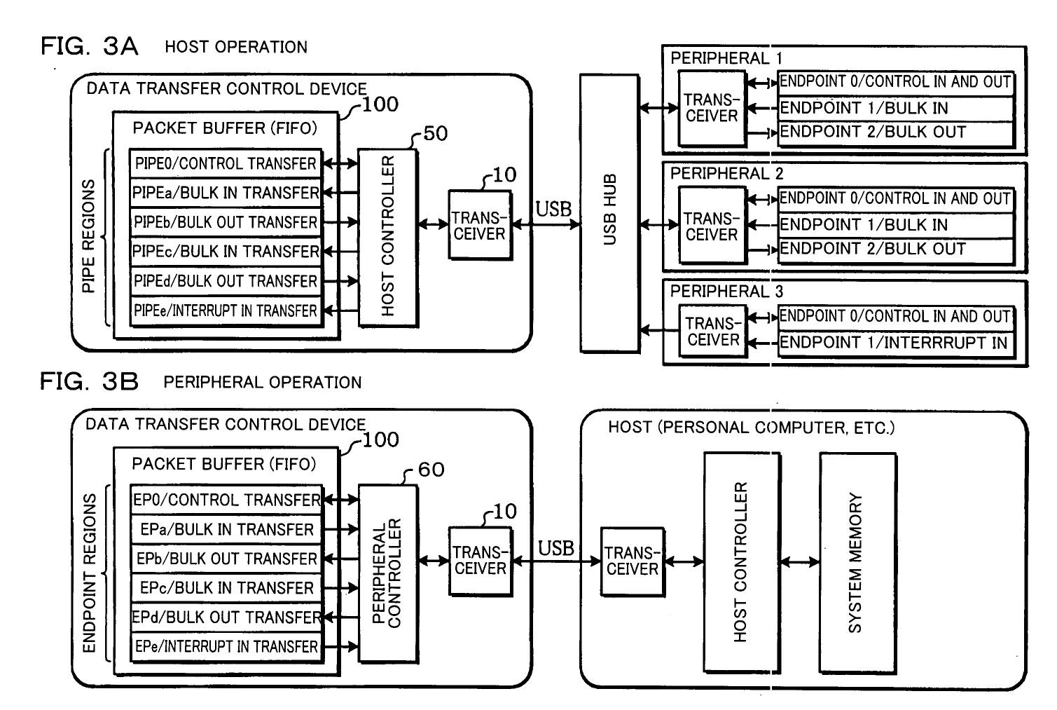

In the present embodiment, the pipe regions PIPE0 to PIPEe are allocated in the packet buffer 100 during the host operation, as shown in FIG. 3A. Data is transferred between each pipe region and each endpoint of a peripheral.

The meaning of the “pipe” of the pipe region in the present embodiment differs to some extent from the “pipe” defined in the USB (a logical abstraction or a logical path representing the association between an endpoint on a device and software on the host).

As shown in FIG. 3A, the pipe region in the present embodiment is allocated in the packet buffer 100 corresponding to each endpoint of a peripheral connected with the USB (bus). In FIG. 3A, the pipe region PIPEa corresponds to an endpoint 1 (bulk IN) of a peripheral 1, and the pipe region PIPEb corresponds to an endpoint 2 (bulk OUT) of the peripheral 1. The pipe region PIPEc corresponds to an endpoint 1 (bulk IN) of a peripheral 2, and the pipe region PIPEd corresponds to an endpoint 2 (bulk OUT) of the peripheral 2. The pipe region PIPEe corresponds to an endpoint 1 (interrupt IN) of a peripheral 3. The pipe region PIPE0 is a pipe region dedicated to an endpoint 0 for control transfer.

In the example shown in FIG. 3A, USB bulk IN transfer is performed between the pipe region PIPEa and the endpoint 1 of the peripheral 1, and bulk OUT transfer is performed between the pipe region PIPEb and the endpoint 2 of the peripheral 1. Bulk IN transfer is performed between the pipe region PIPEc and the endpoint 1 of the peripheral 2, and bulk OUT transfer is performed between the pipe region PIPEd and the endpoint 2 of the peripheral 2. Interrupt IN transfer is performed between the pipe region PIPEe and the endpoint 1 of the peripheral 3. As described above, in the present embodiment, arbitrary data transfer (isochronous transfer, bulk transfer, or interrupt transfer) can be performed between the (general-purpose) pipe region and an endpoint corresponding to the pipe region.

In the present embodiment, data in a given data unit (data unit specified by the total size) is transferred between the pipe region and the endpoint corresponding to the pipe region. As the data unit, a data unit of which transfer is requested by an I/O request packet (IRP), a data unit obtained by dividing this data unit into an appropriate size, or the like may be used. Data transfer (series of transactions) to the endpoint in this data unit may be called the “pipe” in the present embodiment, and a region which stores data (transmission data or reception data) of the “pipe” is the pipe region.

After transfer in a given data unit using the pipe region has finished, the pipe region may be released. The released pipe region may be assigned to an arbitrary endpoint. In the present embodiment, the correspondence between the pipe region and the endpoint can be dynamically changed in this manner.

In the present embodiment, the endpoint regions EP0 to EPe are allocated in the packet buffer 100 during the peripheral operation, as shown in FIG. 3B. Data is transferred between each endpoint region and the host.

In the present embodiment, the buffer regions of the packet buffer 100 are assigned to the pipe regions during the host operation and to the endpoint regions during the peripheral operation. This enables resources of the packet buffer 100 to be used in common during the host operation and the peripheral operation, whereby the use storage capacity of the packet buffer 100 can be saved. The number of pipe regions and endpoint regions is not limited to six. The number of pipe regions and endpoint regions may be arbitrary.

5. Reconstruction of Pipe Region

5.1 Reconstruction Processing

In the method of transferring data by allocating the pipe region in the packet buffer 100 as shown in FIGS. 3A and 3B, reconstruction processing of the pipe region must be performed when a new endpoint is added on the USB or the existing endpoint is deleted. The reconstruction processing includes at least one of processing of deleting the allocated pipe region (existing pipe region), processing of adding a new pipe region (pipe region which does not exist), and processing of changing the size of the allocated pipe region.

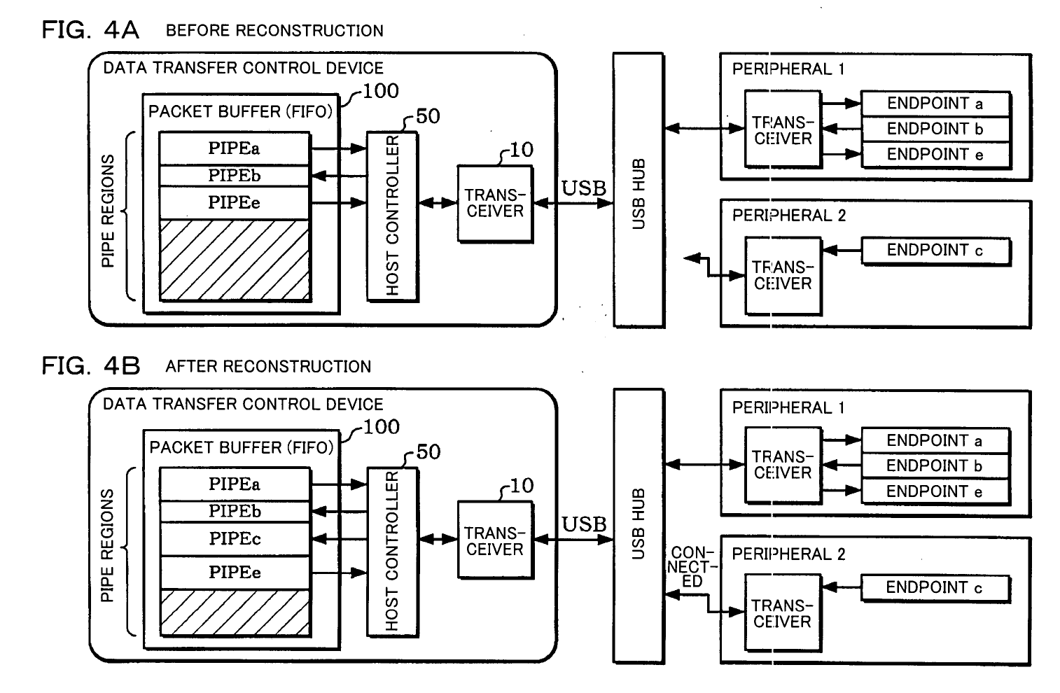

In FIG. 4A, only a peripheral 1 is connected with a USB hub. Since the peripheral 1 (electronic instrument) has endpoints a, b, and e, pipe regions PIPEa, PIPEb, and PIPEe corresponding to the endpoints a, b, and e are allocated in the packet buffer 100.

In FIG. 4B, a peripheral 2 is additionally connected with the USB hub, and an endpoint c of the peripheral 2 is added. In this case, it is necessary to reconstruct the pipe region by adding a pipe region PIPEc corresponding to the endpoint c to the packet buffer 100. When the peripheral 2 is disconnected in a state in which the peripheral 2 is connected with the USB hub as shown in FIG. 4B, it is necessary to reconstruct the pipe region by deleting the pipe region PIPEc corresponding to the endpoint c.

In this case, as a reconstruction method for the pipe region, reallocation processing of the pipe regions PIPEa to PIPEe may be performed after completion of data transfers for all the pipe regions so that the pipe configuration as shown in FIG. 4B is realized.

However, this method makes it necessary to perform the reallocation processing of the pipe regions after waiting for the pipe region to become empty of effective data or removing data remaining in the pipe region after terminating data transfer for the pipe region. However, the transfer cycle for interrupt transfer is as long as 1-255 msec, and the size of IRP data transferred by using the pipe region may be very large. In this case, reconstruction of the pipe region takes a long time by waiting for the pipe region to become empty, whereby convenience to the user is impaired. Moreover, the processing of the CPU (processing section) becomes complicated due to the processing of waiting for the pipe region to become empty or the processing of removing data from the pipe region, whereby the processing load is increased. Furthermore, since the transfer rate at which the partner device transmits data is unknown, it is impossible to estimate the necessary wait time.

Therefore, the present embodiment employs the following method. Specifically, when reconstructing the pipe region (when instructions for reconstruction are issued by the processing section), the transfer controller 40 (host controller 50) shown in FIG. 2 pauses data transfer currently performed between the pipe region (preferably all the pipe regions) and the endpoint. In more detail, when reconstructing the pipe region in the middle of a transaction, the transfer controller 40 pauses the data transfer when the transaction is completed. The transfer controller 40 may pause data transfer after completion of a given number of transactions.

The buffer controller 80 performs the reconstruction processing of the pipe region after the pause processing of data transfers for all the pipe regions (there may be some exceptions) has been completed, for example. In more detail, the buffer controller 80 performs processing of deleting the pipe region, processing of adding the pipe region, or processing of changing the size of the pipe region. The buffer controller 80 performs processing of preventing data stored in the pipe region which exists before and after reconstruction from being destroyed (erased). The buffer controller 80 performs processing of changing only the logical access address of the pipe region without changing the physical access address of the pipe region by using an address translation table. The buffer controller 80 then performs reallocation (ReAllocation, SetBuffer) processing of the pipe regions. After the reallocation processing of all the pipe regions has been completed, the transfer controller 40 resumes the data transfer which has been paused. For example, the transfer controller 40 resumes the data transfer from the transaction subsequent to the transaction which has been completed.

This makes it unnecessary to perform the processing while distinguishing whether the pipe region is used for reception or transmission. Moreover, it is unnecessary to wait for the pipe region to become empty, and the time required for reconstruction of the pipe region can be easily known. Therefore, the reconstruction processing can be completed in a short time, whereby the processing of the firmware can be simplified and the processing load can be reduced.

5.2 Reconstruction Using Address Translation Table

In the present embodiment, an address translation table which translates a logical access address (logical access address block in a narrow sense; hereinafter the same) into a physical access address (physical access address block in a narrow sense; hereinafter the same) is provided, and reconstruction of the pipe region (buffer region in a broad sense) is realized by changing the address translation table. Specifically, reconstruction is realized by changing the correspondence between the logical access address and the physical access address.

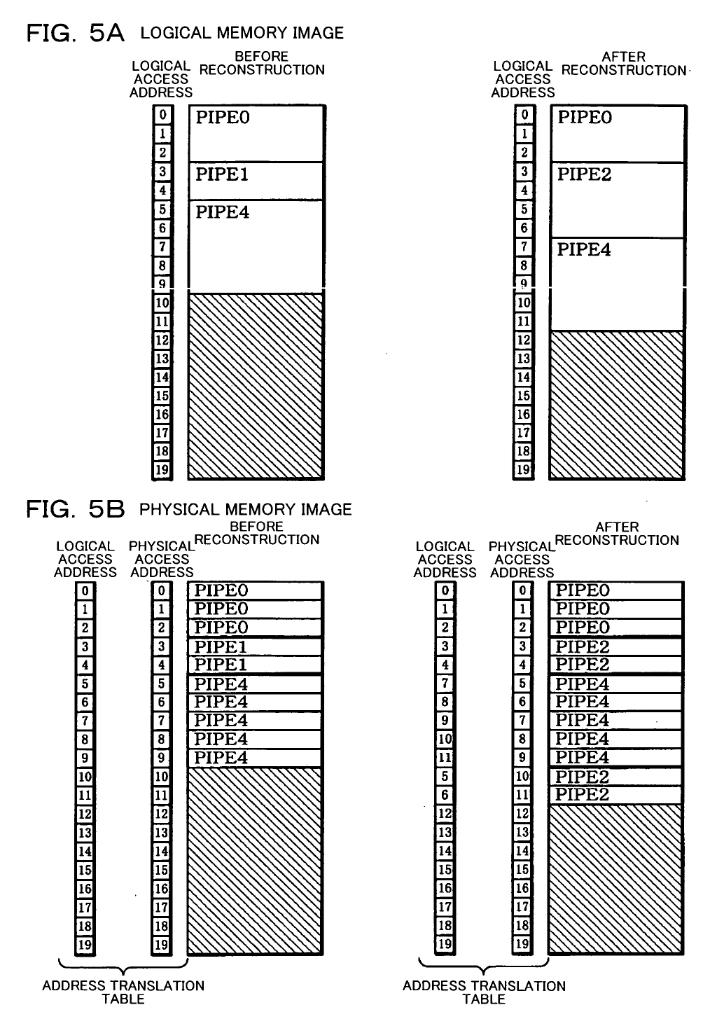

FIG. 5A shows a logical memory image of the packet buffer 100 (RAM) before and after reconstruction. In FIG. 5A, a pipe region PIPE1 which has been allocated before reconstruction is deleted, and a new pipe region PIPE2 is added. Before reconstruction, the logical access addresses (logical access address block) 0-2, 3-4, and 5-9 are continuously assigned to the pipe regions PIPE0, PIPE1, and PIPE4, respectively. After reconstruction, the logical access addresses 0-2, 3-6, and 7-11 are continuously assigned to the pipe regions PIPE0, PIPE2, and PIPE4, respectively. In the present embodiment, since unseparated continuous logical access addresses are assigned to the pipe regions before and after reconstruction, the processing of the firmware (processing section) which manages the logical access address is simplified.

FIG. 5B shows a physical memory image of the packet buffer 100 before and after reconstruction. In FIG. 5B, unseparated continuous logical access addresses are assigned to the pipe regions before and after reconstruction, as described with reference to FIG. 5A. The correspondence between the logical access address and the physical access address is changed in the address translation table so that the physical access addresses of the pipe regions do not change.

In more detail, the pipe region PIPE4 (first pipe region) is allocated in the packet buffer 100 before and after reconstruction corresponding to an endpoint 4 (first endpoint), for example. In the present embodiment, the address translation table is changed so that the physical access addresses of the pipe region PIPE4 do not change even if the logical access addresses change from 5-9 to 7-11. Specifically, the physical access addresses 5-9 of the pipe region PIPE4 are associated with the logical access addresses 5-9 before reconstruction, and the physical access addresses 5-9 of the pipe region PIPE4 are associated with the logical access addresses 7-11 after reconstruction. This prevents a change in the physical access addresses of the pipe region PIPE4, whereby data which has been stored in the pipe region PIPE4 before reconstruction can be prevented from being lost due to reconstruction. Moreover, since the processing of copying data to the pipe region PIPE4 after reconstruction is unnecessary, the reconstruction processing can be simplified. The physical access addresses of the pipe region PIPE2 are discontinuous as shown in FIG. 5B. However, since the logical access addresses of the pipe region PIPE2 are continuous as shown in FIG. 5A, address management of the firmware can be simplified. Therefore, reconstruction of the pipe regions can be realized while minimizing an increase in the processing load of the firmware.

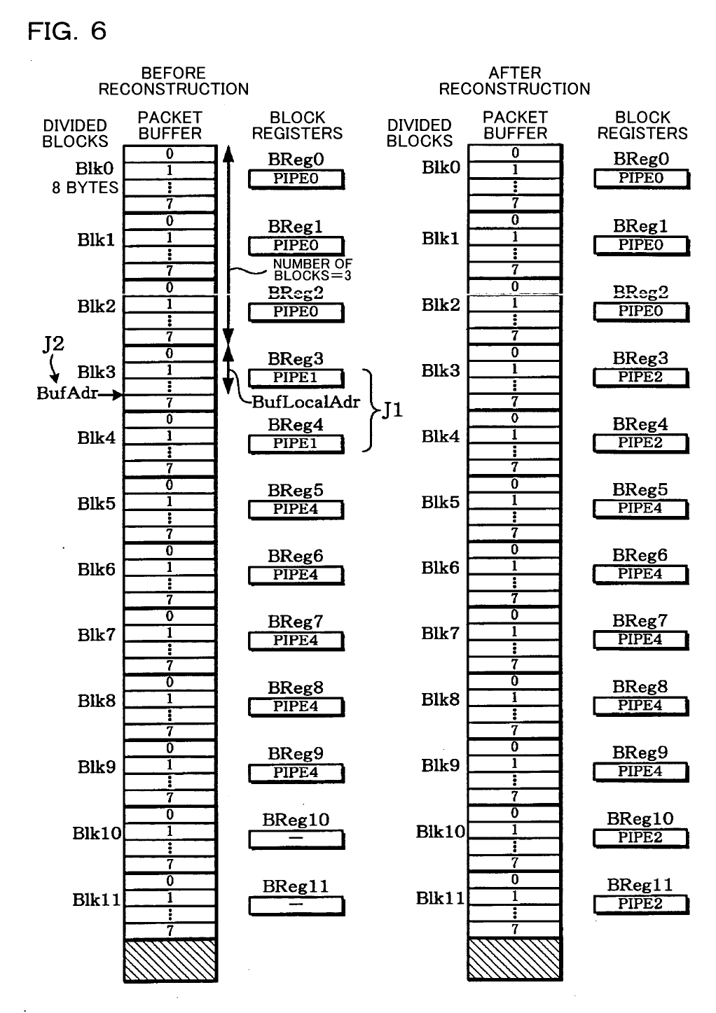

The above-described address translation may be realized by using a method shown in FIG. 6. Specifically, the memory region of the packet buffer 100 is divided into a plurality of divided blocks Blk0 to Blk11. Each of the divided blocks has a size of eight bytes (K bytes in a broad sense), for example. The scale of the address translation table as described later can be reduced by dividing the memory region into divided blocks.

A pipe region number (information for specifying the pipe region) is assigned to the divided blocks Blk0 to Blk11, and the assigned pipe region number is stored. In more detail, the pipe region number (information for specifying the pipe region) assigned to each divided block is stored in block registers BReg0 to BReg11 provided corresponding to the divided blocks Blk0 to Blk11, respectively.

The physical (absolute) access address of the packet buffer 100 is generated based on the pipe region numbers stored in the block registers BReg0 to BReg11, the number of the pipe region to which access is requested, and the relative access address of the pipe region. As indicated by J1 in FIG. 6, the pipe region PIPE1 is assigned to the divided blocks Blk3 and Blk4 before reconstruction, and the number of the pipe region PIPE1 is stored in the block registers BReg3 and BReg4. Therefore, when the number of the pipe region to which access is requested is the number of the pipe region PIPE1, it is specified that the divided blocks Blk3 and Blk4 are accessed. Therefore, when the relative access address of the pipe region PIPE1 (Blk3 and Blk4) is BufLocalAdr, the physical access address is uniquely specified as “BufAdr=number of blocks×K bytes+BufLocalAdr=3×8 bytes+BufLocalAdr”, as indicated by J2 in FIG. 6. This enables access to the requested physical access address.

In the present embodiment, the reconstruction processing (deletion, addition, change in size of the pipe region) is realized by changing the pipe region number assigned to the divided blocks Blk0 to Blk11 of the packet buffer 100.

In FIG. 6, the number of the pipe region PIPE0 is assigned to the divided blocks Blk0 to Blk2 (BReg0 to BReg2), the number of the pipe region PIPE1 is assigned to the divided blocks Blk3 and Blk4 (BReg3 and BReg4), and the number of the pipe region PIPE4 is assigned to the divided blocks Blk5 to Blk9 (BReg5 to BReg9) before reconstruction.

After reconstruction, the number of the pipe region PIPE0 is assigned to the divided blocks Blk0 to Blk2 (BReg0 to BReg2), the number of the pipe region PIPE2 is assigned to the divided blocks Blk3 and Blk4 (BReg3 and BReg4), the number of the pipe region PIPE4 is assigned to the divided blocks Blk5 to Blk9 (BReg5 to BReg9), and the number of the pipe region PIPE2 is assigned to the divided blocks Blk10 and Blk11 (BReg10 and BReg11). The reconstruction processing in which only the logical access address is changed without changing the physical access address as described with reference to FIG. 5B can be realized by changing the pipe region number assigned to the divided block. Since the reconstruction processing can be realized by merely changing the address translation table (by changing the pipe region number stored in the block register), the processing load of the firmware can be reduced.

In FIG. 6, the assignment processing of the divided blocks to the pipe region (buffer region) is realized as described below. The size of each pipe region is calculated based on the maximum packet size (page size) and the number of pages of each pipe region. In FIG. 6, the region sizes of the pipe regions PIPE0, PIPE1, and PIPE4 before reconstruction are respectively 24 bytes, 16 bytes, and 40 bytes. The number of blocks is calculated by dividing the region size by K=8 bytes, which is the size of the divided block. Specifically, the number of blocks of the pipe regions PIPE0, PIPE1, and PIPE4 is respectively 24/8=3 blocks, 16/8=2 blocks, and 40/8=5 blocks.

The divided blocks are sequentially assigned to the pipe regions in order from the pipe region PIPE0 based on the calculated number of blocks. Specifically, since the number of blocks of the pipe region PIPE0 is three, three divided blocks Blk0 to Blk2 are assigned to the pipe region PIPE0, and the number of the pipe region PIPE0 is stored in the block registers BReg0 to BReg2. Since the number of blocks of the pipe region PIPE1 is two, the subsequent two divided blocks Blk3 and Blk4 are assigned to the pipe region PIPE1, and the number of the pipe region PIPE1 is stored in the block registers BReg3 and BReg4. Since the number of blocks of the pipe region PIPE4 is five, the subsequent five divided blocks Blk5 to Blk9 are assigned to the pipe region PIPE4, and the number of the pipe region PIPE4 is stored in the block registers BReg5 to BReg9. The divided blocks can be assigned to the pipe regions after reconstruction in the same manner as described above.

5.3 Operation

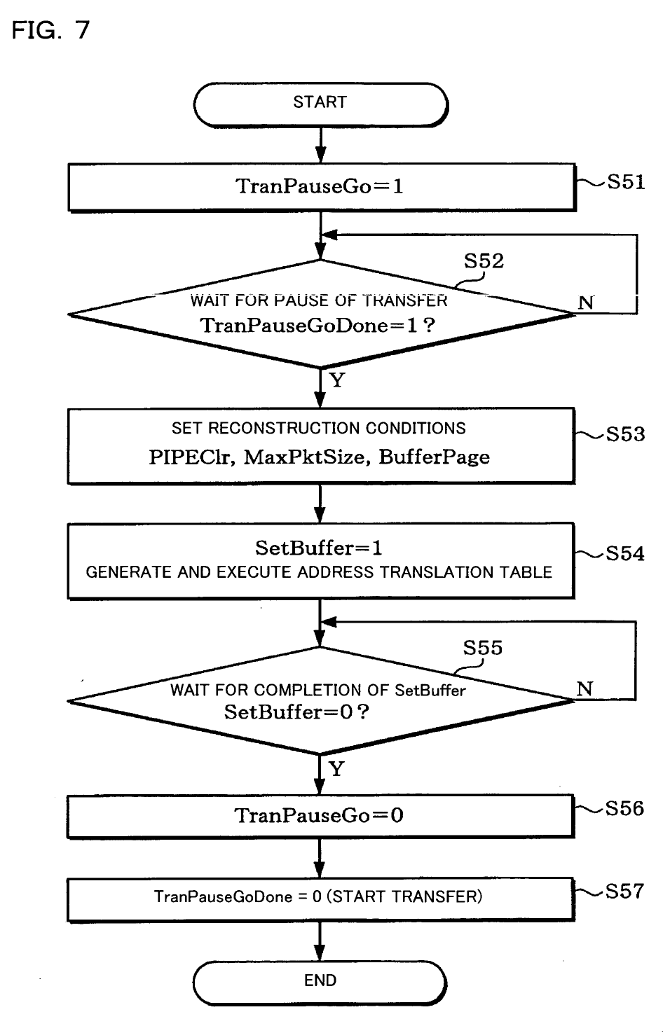

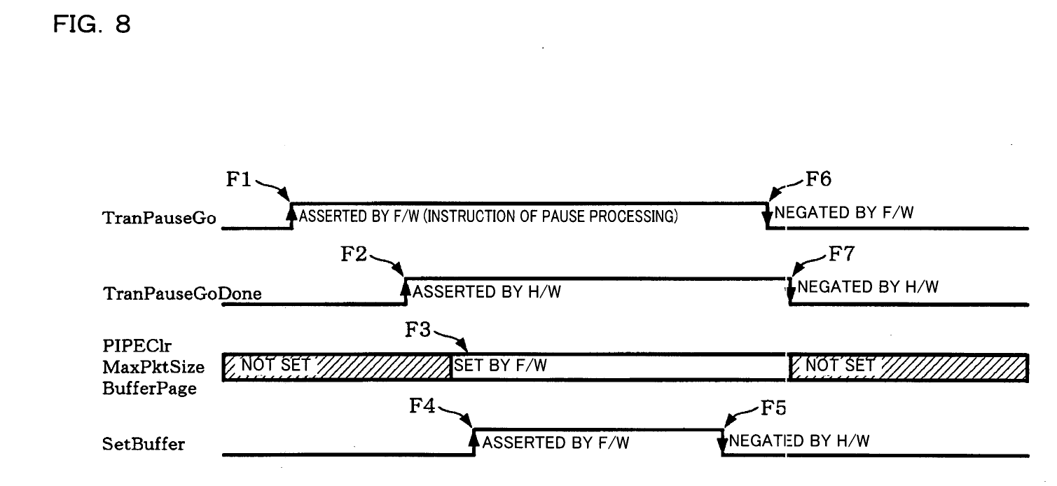

A specific operation during the reconstruction processing is described below by using a flowchart shown in FIG. 7 and a timing waveform diagram shown in FIG. 8. As indicated by F1 in FIG. 8, the firmware (F/W) sets (asserts) a signal TranPauseGo which directs data transfer (USB transfer and DMA transfer) to pause at “1” (step S51). This is realized by allowing the firmware (processing section which controls the data transfer control device in a broad sense; hereinafter the same) to write “TranPauseGo=1” in a TranPauseGo register which is a register for directing the pause processing of data transfer to be performed. This register is provided in the register section 70 shown in FIG. 2, for example.

The firmware waits for data transfer (USB transfer and DMA transfer) to pause (step S52). In more detail, the firmware waits for the hardware circuit (H/W) to write “1” in a TranPauseGoDone register, which is a register for notifying the firmware that the pause processing has been completed for all the pipe regions.

When TranPauseGoDone is set at “1” as indicated by F2 in FIG. 8, the firmware sets reconstruction conditions (PIPEC1r, MaxPktSize, BufferPage, and the like) as indicated by F3 (step S53). This is realized by allowing the firmware to write register values in PIPEC1r, MaxPktSize, and BufferPage registers. These registers are provided in the register section 70, for example.

The PIPEC1r register is a register which allows (instructs) the pipe region to be cleared, and is provided for each pipe region (buffer region). For example, since the pipe region for which PIPEC1r is set at “1” is the target of reconstruction processing, data (write pointer and read pointer) in the pipe region can be cleared. Specifically, the divided block which has been assigned to the pipe region for which PIPEC1r is set at “1” can be assigned to another pipe region after reconstruction. On the other hand, since the pipe region for which PIPEC1r is set at “0” is not the target of reconstruction processing, data (write pointer and read pointer) in the pipe region can be maintained (retained). Specifically, the divided block which has been assigned to the pipe region for which PIPEC1r is set at “0” cannot be assigned to another pipe region after reconstruction. The data which has been stored in the divided block must be maintained.

The MaxPktSize register is a register for setting the maximum packet size (page size in a broad sense) of the pipe region. The BufferPage register is a register for setting the number of pages of the pipe region. The number of divided blocks necessary for allocating each pipe region is calculated based on MaxPktSize (page size) and the number of pages of each pipe region. The pipe region number is assigned to each divided block based on the calculated number of blocks, as shown in FIG. 6.

After the reconstruction conditions are set, the firmware sets “1” in a SetBuffer register which is a register for instructing the hardware circuit to perform the reallocation processing of the pipe regions as indicated by F4 in FIG. 8 (step S54). This allows generation and execution processing of the address translation table to be performed. The firmware waits for completion of the SetBuffer (region reallocation) processing (step S55). When SetBuffer is set at “0” (negated) by the hardware circuit as indicated by F5 in FIG. 8, the firmware sets TranPauseGo at “0” as indicated by F6 (step S56). This allows TranPauseGoDone to be set at “0” by the hardware circuit as indicated by F7, whereby the data transfer which has been paused is resumed (step S57).

A highly efficient and reliable reconstruction processing can be realized by assigning different roles to the firmware (software) and the hardware circuit (buffer controller and transfer controller) as shown in FIGS. 7 and 8. Specifically, the configuration of the hardware circuit can be simplified and the scale of the hardware circuit can be reduced by allowing the firmware to set the reconstruction conditions as indicated by F3 in FIG. 8. Moreover, a highly reliable pause processing and resume processing can be realized by allowing the firmware to instruct the hardware circuit to start or finish the pause processing of the data transfer, as indicated by F1 and F6 in FIG. 8. The firmware and the hardware circuit may be assigned roles which differ from those shown in FIGS. 7 and 8.

5.4 Configuration Example of Buffer Controller

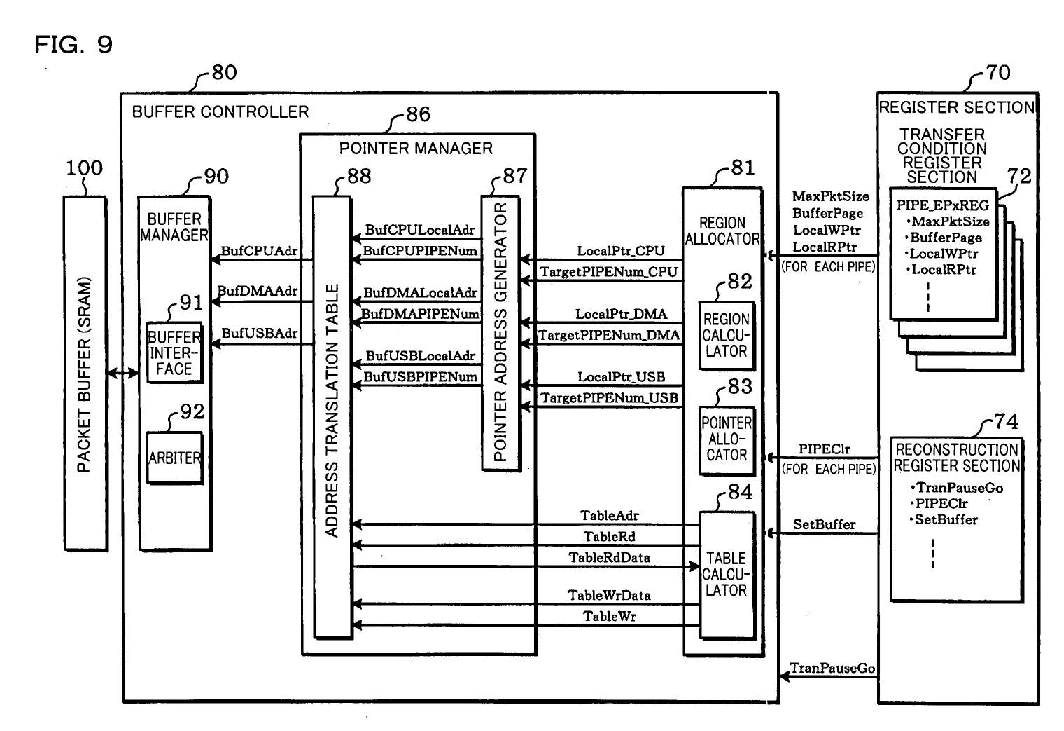

A specific example of a configuration which realizes the reconstruction processing is described below. FIG. 9 shows a configuration example of the buffer controller 80. The buffer controller 80 may have a configuration in which some of the functional blocks shown in FIG. 9 are omitted. Some of the functional blocks (region allocator, pointer manager, address translation table, and the like) may be realized by software.

The buffer controller 80 includes a region allocator 81 (region allocation circuit in a narrow sense). The region allocator 81 allocates a buffer region in the packet buffer 100. The buffer region is a region which is assigned to the pipe region during the host operation and is assigned to the endpoint region during the peripheral operation.

The region allocator 81 includes a region calculator 82, a pointer allocator 83, and a table calculator 84. The region allocator 81 may have a configuration in which some of these circuits are omitted.

The region calculator 82 (region calculation circuit in a narrow sense) calculates the number of blocks used by the buffer region (pipe region or endpoint region) and the like based on the maximum packet size (page size) and the number of pages to specify the start address, end address, and region size of the buffer region, and allocates the buffer region in the packet buffer 100.

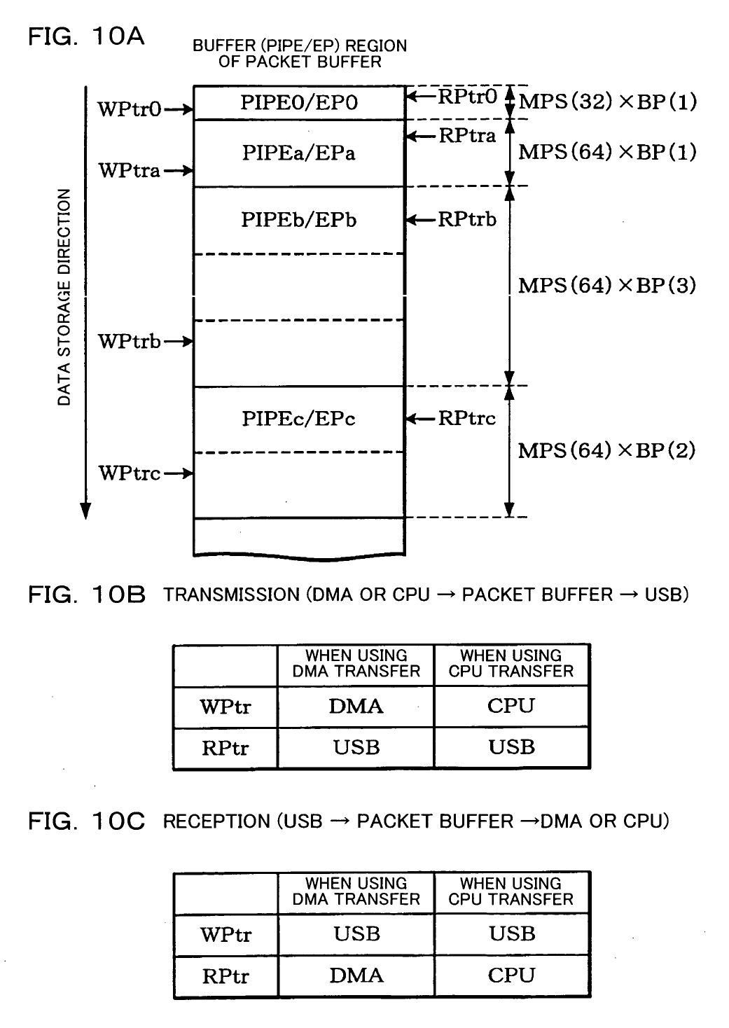

In the buffer regions PIPE0/EP0, PIPEa/EPa, PIPEb/EPb, and PIPEc/EPc shown in FIG. 10A, the maximum packet size (MaxPktSize) is respectively set at 32, 64, 64, and 64 bytes, and the number of pages (BufferPage) is respectively set at 1, 1, 3, and 2 pages. The region calculator 82 calculates the number of blocks (start address, end address, and region size) used by the buffer regions PIPE0/EP0 to PIPEc/EPc based on the maximum packet size, the number of pages, and the like. In FIG. 10A, the region sizes of the buffer regions PIPE0/EP0, PIPEa/EPa, PIPEb/EPb, and PIPEc/EPc are respectively 32 (=32×1), 64 (=64×1), 192 (=64×3), and 128 (=64×2) bytes. When the size of the divided block is K=8 bytes, the number of blocks used by the buffer regions PIPE0/EP0, PIPEa/EPa, PIPEb/EPb, and PIPEc/EPc is respectively 32/K =4, 64/K=8, 192/K=24, and 128/K=16.

The pointer allocator 83 (pointer allocation circuit in a narrow sense) is a circuit which assigns the write pointer WPtr (WPtr0, WPtra, WPtrb, or WPtrc) and the read pointer RPtr (RPtr0, RPtra, RPtrb, or RPtrc) of each buffer region to a DMA pointer, a CPU pointer, or a USB pointer.

As shown in FIG. 10B, when data is transmitted (when data is transferred from DMA or CPU to USB through the packet buffer 100) and DMA transfer is used, the write pointer WPtr of the buffer region is assigned to the DMA (DMA access) pointer, and the read pointer RPtr is assigned to the USB (USB access) pointer. When data is transmitted and CPU (PIO) transfer is used, the write pointer WPtr of the buffer region is assigned to the CPU (CPU access) pointer, and the read pointer RPtr is assigned to the USB pointer.

As shown in FIG. 10C, when data is received (when data is transferred from USB to DMA or CPU through the packet buffer 100) and DMA transfer is used, the write pointer WPtr of the buffer region is assigned to the USB pointer, and the read pointer RPtr is assigned to the DMA pointer. When data is received and CPU transfer is used, the write pointer WPtr of the buffer region is assigned to the USB pointer, and the read pointer RPtr is assigned to the CPU pointer.

The information on the pointers WPtr and RPtr of each buffer region is retained in each transfer condition register (PIPE/EP register) in the register section 70 as relative access address information LocalWPtr and LocalRPtr.

The table calculator 84 (table calculation circuit in a narrow sense) performs change processing of an address translation table 88. In more detail, the table calculator 84 sequentially reads the pipe region number assigned to each divided block from the address translation table 88. The table calculator 84 performs rewrite processing of the pipe region number assigned to the divided block on condition that the pipe region specified by the read pipe region number can be cleared (PIPEC1r=1).

The buffer controller 80 includes a pointer manager 86 (pointer management circuit in a narrow sense). The pointer manager 86 controls access to the buffer region based on relative pointers LocalPtr_CPU, LocalPtr_DMA, and LocalPtr_USB for the CPU, DMA, and USB which point to the relative access address of the buffer region (pipe region). Specifically, the pointer manager 86 generates physical access addresses BufCPUAdr, BufDMAAdr, and BufUSBAdr for the CPU (processing section), DMA (application layer device), and USB (transfer controller) for accessing the packet buffer 100 based on the pointers LocalPtr_CPU, LocalPtr_DMA, and LocalPtr_USB. TargetPIPENum_CPU, TargetPIPENum_DMA, and TargetPIPENum_USB are the pipe region numbers to be accessed from the CPU, DMA, and USB.

The pointer manager 86 includes a pointer address generator 87 (pointer address generation circuit in a narrow sense). The pointer address generator 87 generates relative access addresses BufCPULocalAdr, BufDMALocalAdr, and BufUSBLocalAdr pointed by the pointers LocalPtr_CPU, LocalPtr_DMA, and LocalPtr_USB based on these pointers. The pointer address generator 87 outputs access request pipe region numbers BufCPUPIPENum, BufDMAPIPENum, and BufUSBPIPENum corresponding to these relative access addresses.

The pointer manager 86 includes the address translation table 88 (address translation table circuit in a narrow sense). The address translation table 88 generates physical (absolute) access addresses BufCPUAdr, BufDMAAdr, and BufUSBAdr by translating the relative access addresses BufCPULocalAdr, BufDMALocalAdr, and BufUSBLocalAdr.

5.5 Configuration Example of Address Translation Table

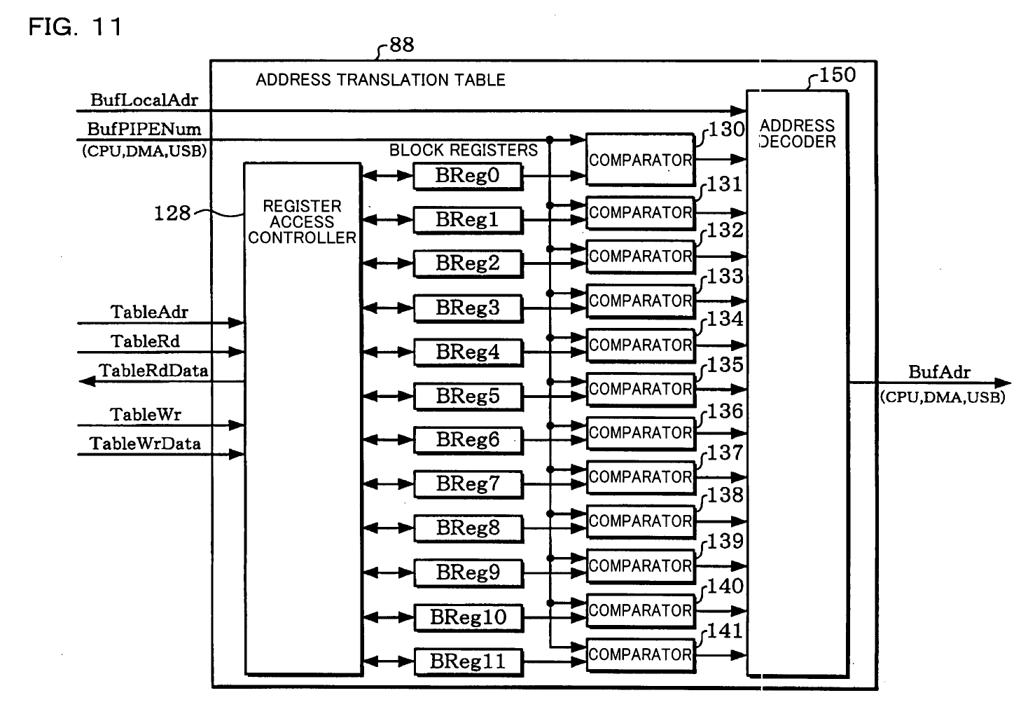

FIG. 11 shows a configuration example of the address translation table 88. The address translation table 88 may have a configuration in which some of the functional blocks shown in FIG. 11 are omitted. The address translation table shown in FIG. 11 may be provided for each of CPU access, DMA access, and USB access. In this case, a register access controller 128 and the block registers BReg0 to BReg11 may be used in common. FIG. 11 illustrates the case where the number of block registers is 12 (number of divisions is 12). However, the number of block registers is not limited thereto.

The register access controller 128 controls access (read or write of data) to the block registers BReg0 to BReg11. In more detail, when TableRd is asserted, the register access controller 128 reads data from the block register addressed by TableAdr, and outputs the read data to the table calculator 84 shown in FIG. 9 as TableRdData. When TableWd is asserted, the register access controller 128 writes write data TableWrData from the table calculator 84 into the block register addressed by TableAdr.

The block registers BReg0 to BReg11 store the pipe region number assigned to each divided block as described with reference to FIG. 6. Comparators 130 to 141 respectively compare the pipe region number stored in the block registers BReg0 to BReg11 with the pipe region number BufPIPENum to which access is requested (BufCPUPIPENum, BufDMAPIPENum, or BufUSBPIPENum), and output the comparison results to an address decoder 150. The address decoder 150 performs decode processing based on the comparison result and the relative access address BufLocalAdr (BufCPULocalAdr, BufDMALocalAdr, or BufUSBLocalAdr) corresponding to the pipe region, and generates and outputs a physical (absolute) access address BufAdr (BufCPUAdr, BufDMAAdr, or BufUSBAdr).

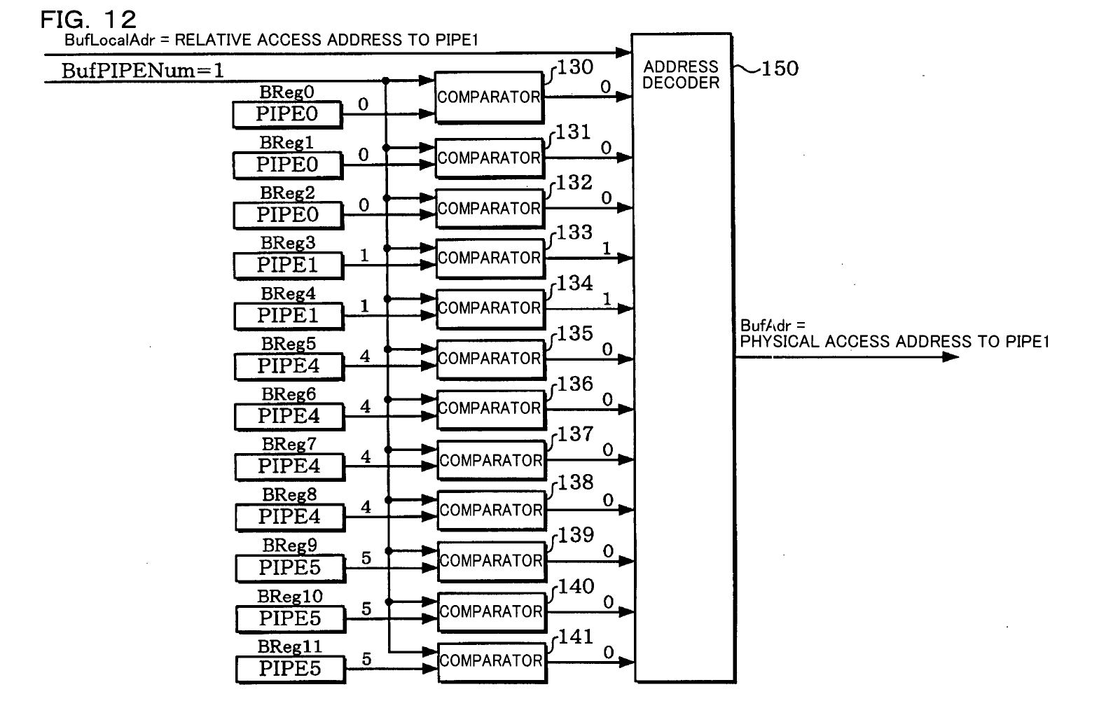

In FIG. 12, the number of the pipe region PIPE0 is stored in the block registers BReg0 to BReg2, the number of the pipe region PIPE1 is stored in the block registers BReg3 and BReg4, the number of the pipe region PIPE4 is stored in the block registers BReg5 to BReg8, and the number of the pipe region PIPE5 is stored in the block registers BReg9 to BReg11. The pipe region number BufPIPENum to which access is requested is “1”. Therefore, only the comparators 133 and 134 corresponding to the block registers BReg3 and BReg4 which store the number of the pipe region PIPE1 output “1” (assert), and the other comparators 130 to 132 and 135 to 141 output “0” (negate). Therefore, the address decoder 150 can uniquely determine the physical access address BufAdr which should be generated based on the comparison result. For example, when the size of the divided block is K=8 bytes, “BufAdr=number of blocks×K bytes+BufLocalAdr=3×8 bytes+BufLocalAdr” is generated. This allows the physical access address of the pipe region PIPE1 to be generated, whereby the pipe region PIPE1 can be accessed.

5.6 Configuration Example of Table Calculator

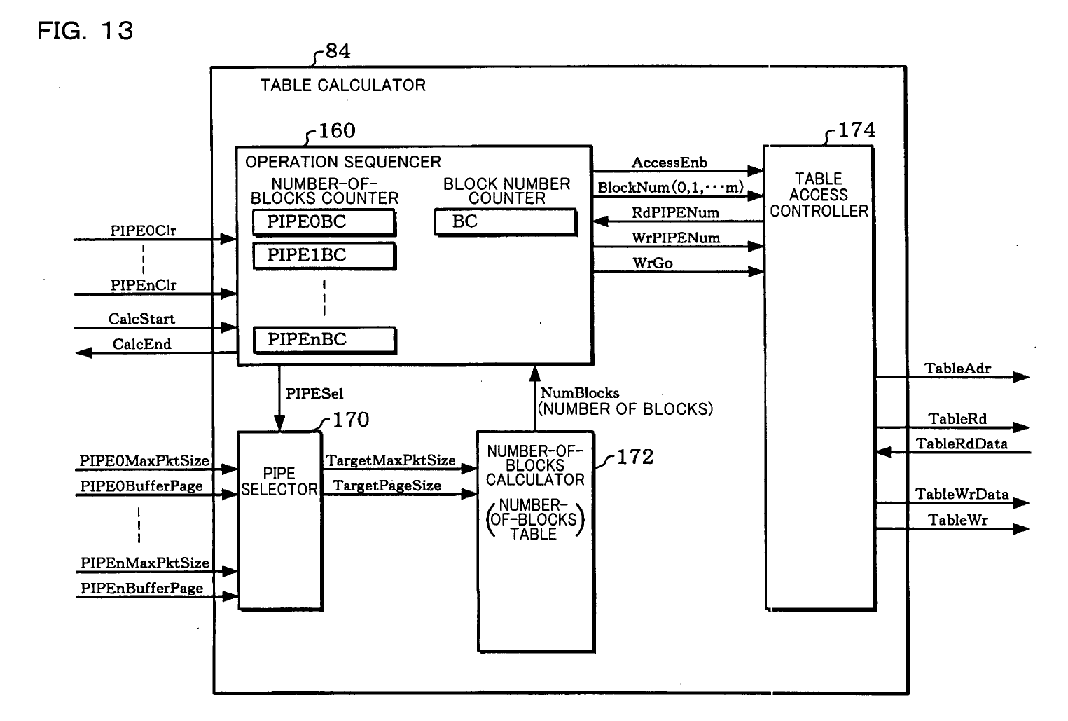

FIG. 13 shows a configuration example of the table calculator 84. The table calculator 84 may have a configuration in which some of the functional blocks shown in FIG. 13 are omitted.

In FIG. 13, an operation sequencer 160 controls an operation sequence. A pipe selector 170 selects information on the processing target pipe region. A number-of-blocks calculator 172 (number-of-blocks table) calculates the number of blocks of each pipe region. A table access controller 174 controls access to the address translation table 88.

When a calculation start signal CalcStart is asserted, the operation sequencer 160 starts to operate, and the pipe regions are processed in order from pipe region PIPE0. The calculation start signal CalcStart is asserted when SetBuffer is set at “1”. When the calculation start signal CalcStart is asserted, the operation sequencer 160 instructs the selector 170 to select the pipe region PIPE0 by using a select signal PIPESel. The selector 170 selects the maximum packet size PIPE0MaxPktSize and the number of pages PIPE0BufferPage of the pipe region PIPE0, and output these to the number-of-blocks calculator 172.

The number-of-blocks calculator 172 calculates the number of blocks uniquely determined from the combination of the maximum packet size and the number of pages by using the table, and outputs the number of blocks as NumBlocks. If the size of one divided block is 32 bytes, PIPE0MaxPktSize is 16 bytes, and PIPE0BufferPage is four, the number of blocks NumBlocks used by the pipe region PIPE0 is (16×4)/32=2. This number of blocks is set as the counter value of a number-of-blocks counter PIPE0BC for the pipe region PIPE0. The number of blocks used by all the pipe regions is set as the counter values of the number-of-blocks counters PIPE0BC to PIPEnBC.

When the number of blocks is set for all the pipe regions, the operation sequencer 160 controls access to the block registers BReg0 to BReg11 of the address translation table 88 based on the counter value of the number-of-blocks counter BC which counts the divided block number. Specifically, in order to access the block register BReg0 of the address translation table 88, the operation sequencer 160 sets an access block number BlockNum at “0”, and outputs an access enable signal AccessEnb to the table access controller 174.

The table access controller 174 outputs read access signals TableAdr and TableRd based on the access block number BlockNum, and reads the contents of the block register BReg0 of the address translation table 88. This allows the pipe region number stored in the block register BReg0 to be read, and the operation sequencer 160 is notified of the read pipe region number as RdPIPENum.

When RdPIPENum is the number of the pipe region PIPE2, the divided block Blk0 has been assigned to the pipe region PIPE2 before reconstruction. If the clear signal PIPE2C1r for the pipe region PIPE2 is set at “1” and the pipe region PIPE2 is the reconstruction target, it is unnecessary to maintain the state of the block register BReg0. Therefore, the register value of the block register BReg0 can be rewritten with the number of the pipe region PIPE0.

The operation sequencer 160 sets a write pipe region number WrPIPENum at “0”, and asserts a write start signal WrGo. This causes the table access controller 174 to output write access signals TableAdr and TableWr to write the number of the pipe region PIPE0 into the block register BReg0 of the address translation table 88.

If two divided blocks are assigned to the pipe region PIPE0, one of the divided blocks is assigned to the pipe region PIPE0 by the above-described processing. Therefore, the counter value of the number-of-blocks counter PIPE0BC is decremented by one, and processing of the next divided block is performed. The change processing of the address translation table 88 (block register) is completed by repeating the above-described processing until the counter values of all the number-of-blocks counters become zero.

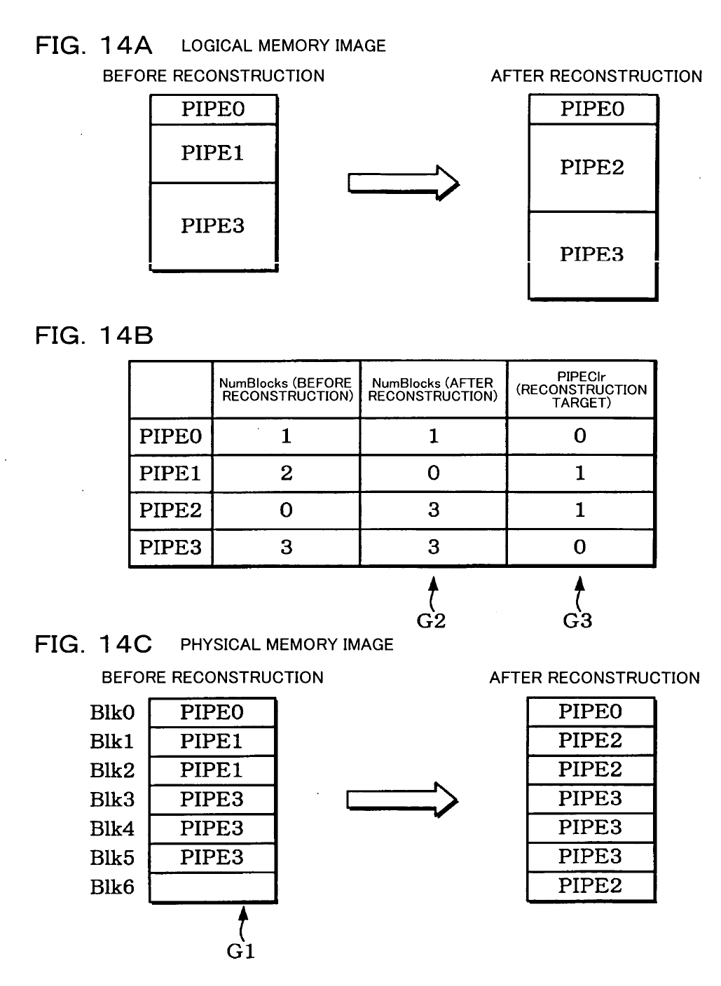

The case of performing the reconstruction processing as shown in a logical memory image in FIG. 14A is considered below. In FIG. 14A, the pipe region PIPE1 is deleted and the pipe region PIPE2 is added by reconstruction. In this case, the number of blocks NumBlocks of the pipe regions PIPE0, PIPE1, PIPE2, and PIPE3 before reconstruction is respectively 1, 2, 0, and 3, as shown in FIG. 14B. The number of blocks NumBlocks of the pipe regions PIPE0, PIPE1, PIPE2, and PIPE3 after reconstruction is respectively 1, 0, 3, and 3. Since the pipe regions PIPE1 and PIPE2 are reconstruction targets, the pipe clear signal PIPEC1r is set at “0” for the pipe regions PIPE0 and PIPE3, and set at “1” for the pipe regions PIPE1 and PIPE2.

As a result, the pipe regions are assigned to the divided blocks Blk0 to Blk6 (block registers BReg0 to BReg6) by reconstruction as shown in a physical memory image in FIG. 14C. Specifically, since the pipe region PIPE1 is deleted by reconstruction, the pipe region PIPE2 is assigned to the divided blocks Blk1 and Blk2 to which the pipe region PIPE1 has been assigned before reconstruction. Since the clear signal PIPEC1r for the pipe region PIPE3 is set at “0” so that data in the pipe region PIPE3 is maintained, the pipe region PIPE3 is assigned to the divided block Blk3 instead of the pipe region PIPE2. The pipe region PIPE3 is assigned to the divided blocks Blk4 and Blk5. The pipe region PIPE2 is assigned to the remaining divided block Blk6.

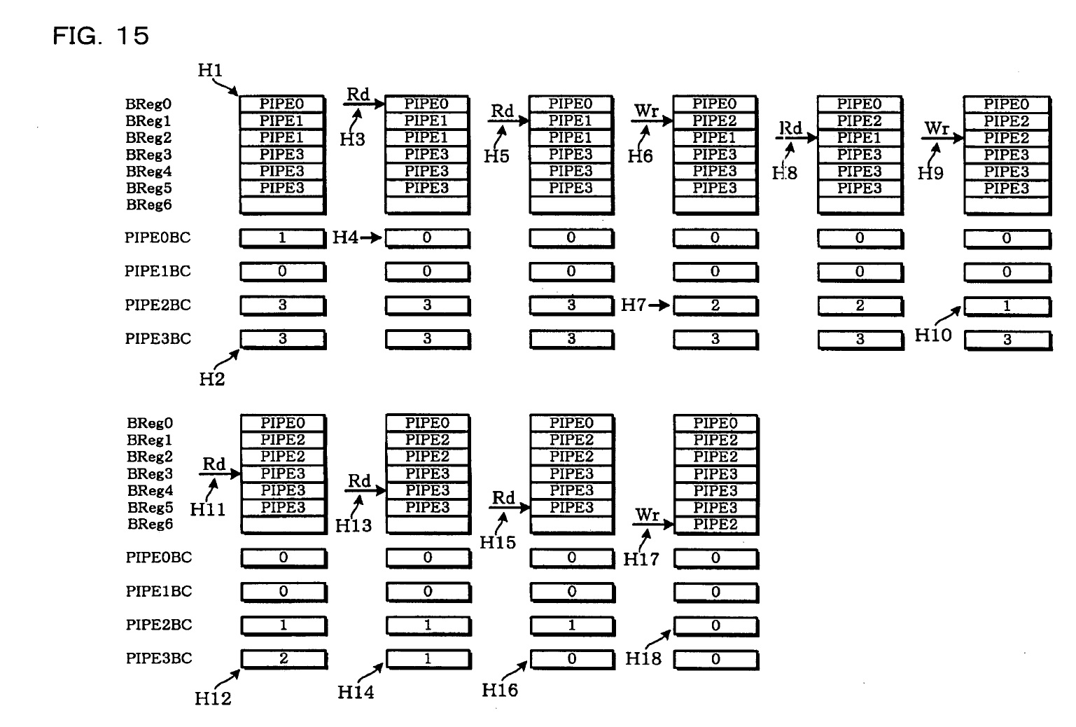

The operation of the above-described reconstruction processing is described below with reference to FIG. 15. Since the physical memory image before reconstruction is as indicated by G1 in FIG. 14C, the pipe region number is stored in the block registers BReg0 to BReg6 as indicated by H1 in FIG. 15. Since the number of blocks NumBlocks after reconstruction is calculated by the number-of-blocks calculator 172 as indicated by G2 in FIG. 14B, the number of blocks is set to the number-of-blocks counters PIPE0BC to PIPE3BC as indicated by H2 in FIG. 15.

As indicated by H3 in FIG. 15, the register value of the block register BReg0 of the address translation table 88 is read by the table access controller 174. In this case, the number of the pipe region PIPE0 is read from the block register BReg0. The pipe region PIPE0 is not a reconstruction target since the pipe clear signal PIPECr is set at “0” as indicated by G3 in FIG. 14B. Therefore, the number of the pipe region PIPE0 is assigned to the block register BReg0 (Blk0). Therefore, the counter value of the number-of-blocks counter PIPE0BC is decremented by one to become zero, as indicated by H4. In the present embodiment, each time the pipe region number is assigned to the divided block (block register), the number of blocks in the number-of-blocks counter corresponding to the pipe region number is decremented.

As indicated by H5 in FIG. 15, the register value of the block register BReg1 is read by the table access controller 174. In this case, the number of the pipe region PIPE1 is read from the block register BReg1. The pipe region PIPE1 is a reconstruction target since the pipe clear signal PIPEC1r is set at “1” as indicated by G3 in FIG. 14B. Therefore, rewrite processing is performed by writing the number of the pipe region PIPE2 into the block register BReg1 by the table access controller 174, as indicated by H6. This causes the counter value of the number-of-blocks counter PIPE2BC to be decremented by one to become two, as indicated by H7. As indicated by H8, H9, and H10, the number of the pipe region PIPE2 is written into the block register BReg2, and the counter value of the number-of-blocks counter PIPE2BC is decremented by one to become one.

In the present embodiment, the rewrite processing of the pipe region number assigned to the divided block is performed on condition that the pipe region specified by the read pipe region number can be cleared (PIPEC1r=1).

As indicated by H11 in FIG. 15, the register value of the block register BReg3 is read. In this case, the number of the pipe region PIPE3 is read from the block register BReg3. The pipe region PIPE3 is not a reconstruction target since the pipe clear signal PIPEC1r is set at “0”, as indicated by G3 in FIG. 14B. Therefore, the number of the pipe region PIPE3 is assigned to the block register BReg3, and the counter value of the number-of-blocks counter PIPE3BC is decremented by one to become two as indicated by H12. As indicated by H13, H14, H15, and H16, the number of the pipe region PIPE3 is assigned to the block registers BReg4 and BReg5, whereby the counter value of the number-of-blocks counter PIPE3BC becomes zero.

As indicated by H17 in FIG. 15, the number of the pipe region PIPE2 is written into the block register BReg6, and the counter value of the number-of-blocks counter PIPE2BC is decremented by one to become zero as indicated by H18. Therefore, the counter values of all the number-of-blocks counters PIPE0BC to PIPE3BC become zero, whereby the reconstruction processing is completed.

As described above, in the present embodiment, the pipe regions can be efficiently allocated so that a free area is not formed in the packet buffer 100 after reconstruction by utilizing the number-of-blocks counters PIPE0BC to PIPE3BC and the clear signal PIPEC1r.

6. Transfer Condition Register (Common Register)

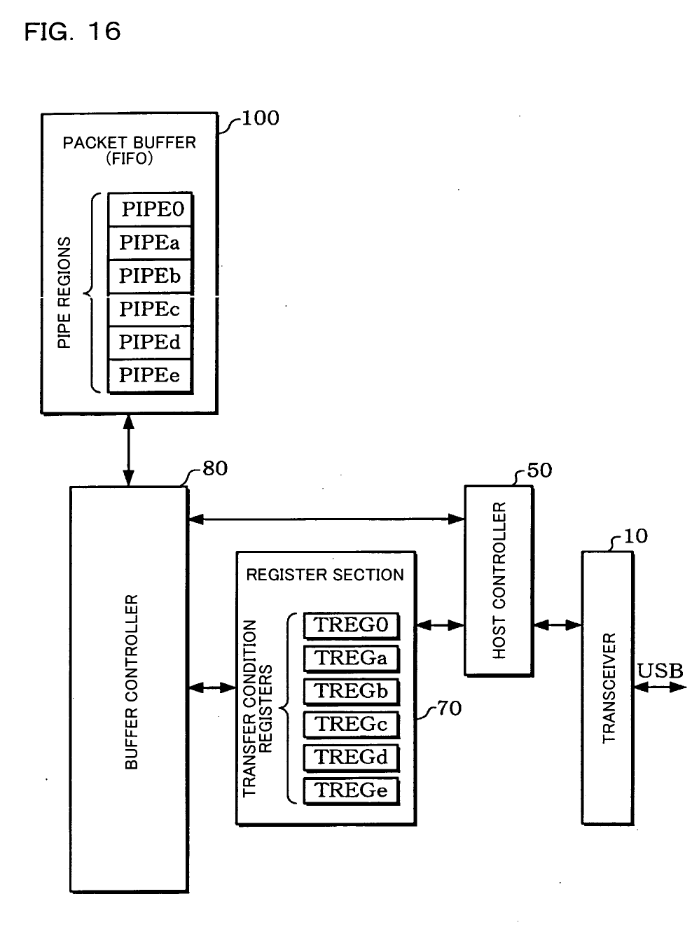

In the present embodiment, the transfer condition information on data transfer performed between the pipe regions PIPE0 to PIPEe and the endpoints is set in transfer condition registers TREG0 to TREGe during the host operation, as shown in FIG. 16. Specifically, the transfer condition information on the pipe regions PIPE0, PIPEa, PIPEb, PIPEc, PIPEd, and PIPEe is respectively set (stored) in the transfer condition registers TREG0, TREGa, TREGb, TREGc, TREGd, and TREGe. The transfer condition information is set by the firmware (CPU or processing section), for example.

The host controller 50 (transfer controller in a broad sense) generates transactions to the endpoints based on the transfer condition information set in the transfer condition registers TREG0 to TREGe. The host controller 50 automatically transfers data (packet) between the pipe region and the endpoint corresponding to the pipe region.

In the present embodiment, each transfer condition register is provided corresponding to each pipe region (buffer region). Pipe transfer (transfer in a given data unit) of each pipe region is automatically performed by the host controller 50 based on the transfer condition information set in each transfer condition register. Therefore, it is unnecessary for the firmware (driver or software) to take part in data transfer control after setting the transfer condition information in the transfer condition registers until the data transfer is completed. An interrupt occurs when the pipe transfer in a given data unit is completed, whereby the firmware is advised of completion of transfer. This significantly reduces the processing load of the firmware (CPU).

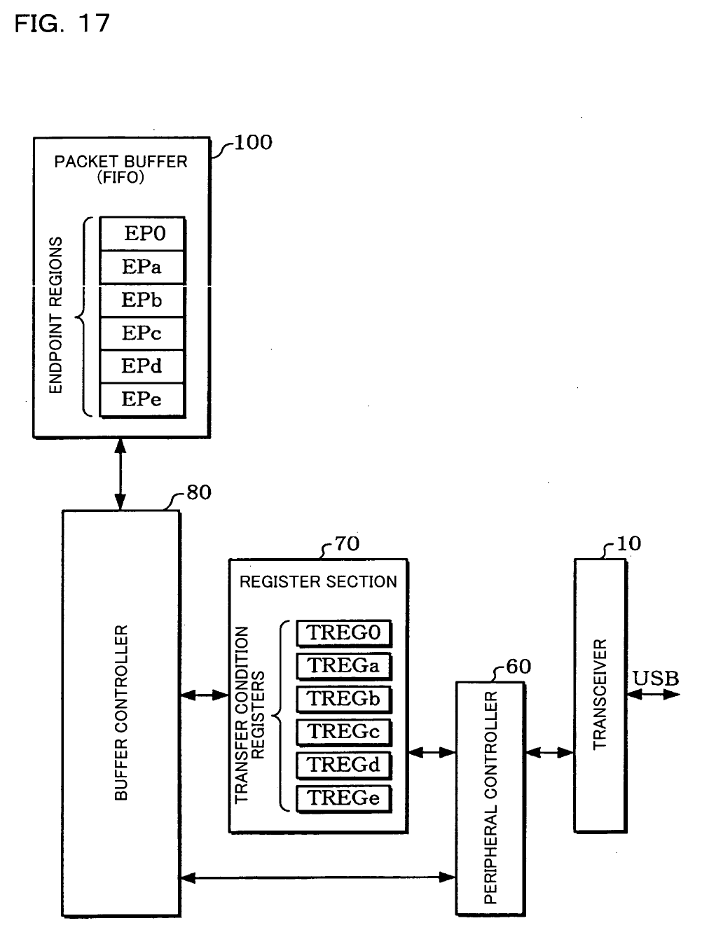

In the present embodiment, the transfer condition information on data transfers performed between the endpoint regions EP0 to EPe and the host is set in the transfer condition registers TREG0 to TREGe during the peripheral operation, as shown in FIG. 17. The peripheral controller 60 (transfer controller in a broad sense) performs data transfer between the endpoint regions and the host based on the transfer condition information set in the transfer condition registers TREG0 to TREGe.

As described above, in the present embodiment, the transfer condition registers TREG0 to TREGe are used in common during the host operation and the peripheral operation. This saves resources of the register section 70, whereby the scale of the data transfer control device can be reduced.

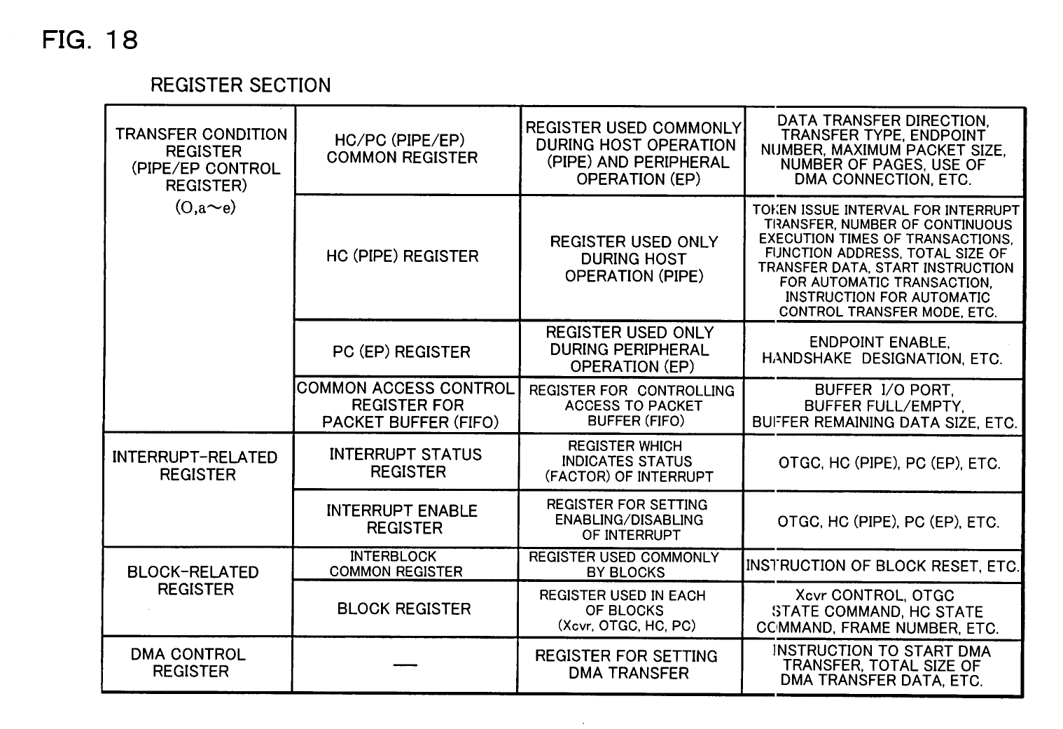

FIG. 18 shows a configuration example of the registers in the register section 70. Some of the registers in the register section 70 may be included in each block (OTGC, HC, PC, Xcvr, and the like).

As shown in FIG. 18, the transfer condition registers (each of TREG0 to TREGe) in the register section 70 include HC/PC common registers (common transfer condition registers) which are used in common during the host operation (HC, PIPE) and the peripheral operation (PC, EP). The transfer condition registers include HC (PIPE) registers (host transfer condition registers) which are used during only the host operation. The transfer condition registers include PC (EP) registers (peripheral transfer condition registers) which are used during only the peripheral operation. The transfer condition registers also include access control registers which are registers for controlling access to the packet buffer (FIFO), and are used in common during the host operation and the peripheral operation.

For example, the host controller 50 (HC) transfers data (packet) based on the transfer condition information set in the HC/PC common registers and the HC registers during the host operation of the dual-role device. The peripheral controller 60 (PC) transfers data (packet) based on the transfer condition information set in the HC/PC common registers and the PC registers during the peripheral operation.

The buffer controller 80 controls access to the packet buffer 100 (generation of read/write address, read/write of data, arbitration between accesses, and the like) based on the common access control registers during the host operation and the peripheral operation.

A data transfer direction (IN, OUT, SETUP, and the like), transfer type (transaction type such as isochronous, bulk, interrupt, and control), endpoint number (number associated with the endpoint of each USB device), and maximum packet size (maximum payload size of a packet which can be transmitted or received by the endpoint; page size) are set in the HC/PC common registers shown in FIG. 18. The number of pages (number of layers of buffer region) of the buffer region (pipe region or endpoint region) is set. Information indicating whether or not to use DMA connection (whether or not to use DMA transfer by the DMA handler circuit 112) is set in the HC/PC common registers.

A token issue interval of interrupt transfer (interval for starting interrupt transaction) is set in the HC (PIPE) registers. The number of continuous execution times of transactions (information which sets a transfer ratio between the pipe regions; number of continuous execution times of transactions in each pipe region) is set in the HC (PIPE) registers. A function address (USB address of a function having endpoints) and the total size of data to be transferred (total size of data transferred through each pipe region; data unit such as IRP) are set in the HC (PIPE) registers. A start instruction for automatic transactions (instruction requesting the host controller to start automatic transaction processing) is set in the HC (PIPE) registers. An instruction for an automatic control transfer mode (instruction for a mode which automatically generates transactions in a setup stage, data stage, and status stage of control transfer) is also set in the HC (PIPE) registers.

Endpoint enable (instruction for enabling or disabling endpoint) and handshake designation (designation of a handshake performed in each transaction) are set in the PC (EP) register.

A buffer I/O port (I/O port when performing PIO transfer by the CPU) is set in the common access control register for the packet buffer (FIFO). Buffer full/empty (notification of full/empty of each buffer region) and a remaining buffer data size (remaining data size of each buffer region) are also set in the common access control register. The register section 70 includes interrupt-related registers, block-related registers, and DMA control registers, as shown in FIG. 18.

In the present embodiment, the registers used in common during the host operation and the peripheral operation (HC/PC common registers and common access control registers) are provided in the register section 70. This enables the scale of the register section 70 to be decreased in comparison with the case of separately providing registers for the host operation and registers for the peripheral operation. Moreover, the access addresses of the common registers from the firmware (processing section) which operates on the CPU are the same during the host operation and the peripheral operation. Therefore, the firmware can manage the common registers using the single addresses, whereby the processing of the firmware can be simplified.

The transfer conditions characteristic of transfer during the host operation (PIPE) and transfer during the peripheral operation (EP) can be set by providing the HC registers and the PC registers. For example, a token for interrupt transfer can be issued at a desired interval during the host operation by setting the token issue interval. The transfer ratio between the pipe regions can be arbitrarily set during the host operation by setting the number of continuous execution times. The size of data automatically transferred through the pipe regions during the host operation can be arbitrarily set by setting the total size. The firmware can instruct start of automatic transactions and on/off of the automatic control transfer mode during the host operation.

7. Automatic Transaction

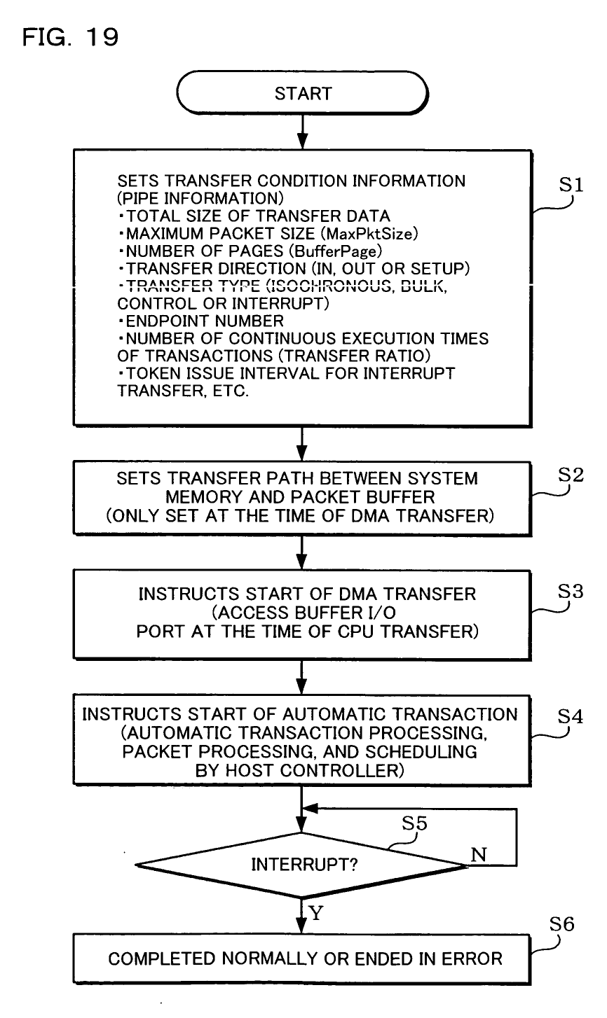

FIG. 19 shows an example of a flowchart of firmware processing during automatic transaction (IN, OUT) processing of the host controller 50.

The firmware (processing section or driver) sets the transfer condition information (pipe information) in the transfer condition registers described with reference to FIG. 18 and the like (step S1). In more detail, the firmware sets the total size of data to be transferred, maximum packet size (MaxPktSize), number of pages (BufferPage), transfer direction (IN, OUT, or SETUP), transfer type (isochronous, bulk, control, or interrupt), endpoint number, number of continuous execution times of transactions (transfer ratio) in the pipe region, token issue interval for interrupt transfer, and the like in the transfer condition registers.

The firmware sets a transfer path between the external system memory and the packet buffer 100 (step S2). Specifically, the firmware sets the DMA transfer path through the DMA handler circuit 112 shown in FIG. 2.

The firmware instructs to start DMA transfer (step S3). Specifically, the firmware asserts a DMA transfer start instruction bit of the DMA control register shown in FIG. 18. In transfer by the CPU, the packet buffer 100 can be accessed by accessing the buffer I/O port shown in FIG. 18.

The firmware instructs to start automatic transactions (step S4). Specifically, the firmware asserts an automatic transaction start instruction bit of the HC register (pipe register) shown in FIG. 18. This allows the host controller 50 to perform automatic transaction processing, packet processing (assembling/disassembling of packet), and scheduling processing. Specifically, the host controller 50 automatically transfers data specified by the total size in a direction (IN or OUT) specified by the transfer direction by using the packet with a payload of the maximum packet size.

The order of the processing in the step S3 and the processing in the step S4 shown in FIG. 19 is not limited. The start instruction for DMA transfer may be issued after the start instruction for automatic transactions.

The firmware waits for occurrence of an interrupt which notifies of the completion of pipe transfer (step S5). When an interrupt occurs, the firmware checks the interrupt status (factor) of the interrupt-related registers shown in FIG. 18. The processing is then completed normally or ends in error (step S6).

According to the present embodiment, the firmware merely sets the transfer condition information for each pipe region (step S1), instructs start of DMA transfer (step S3), and instructs start of automatic transactions (step S4). The subsequent data transfer processing is automatically performed by the hardware circuit of the host controller 50. Therefore, the processing load of the firmware is reduced in comparison with the method conforming to the OHCI, whereby a data transfer control device suitable for an portable instrument including a low performance CPU can be provided.

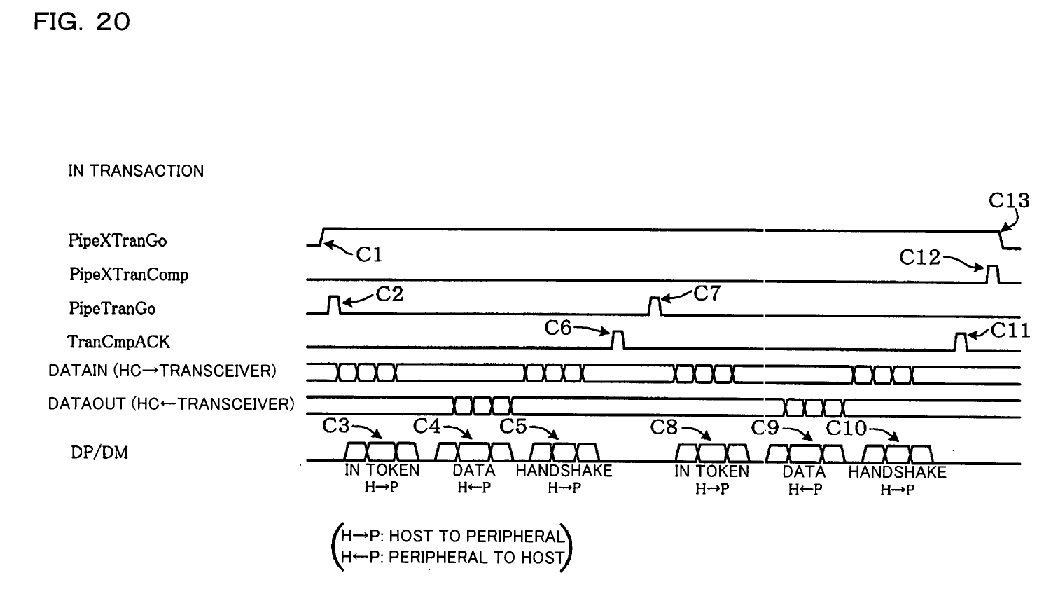

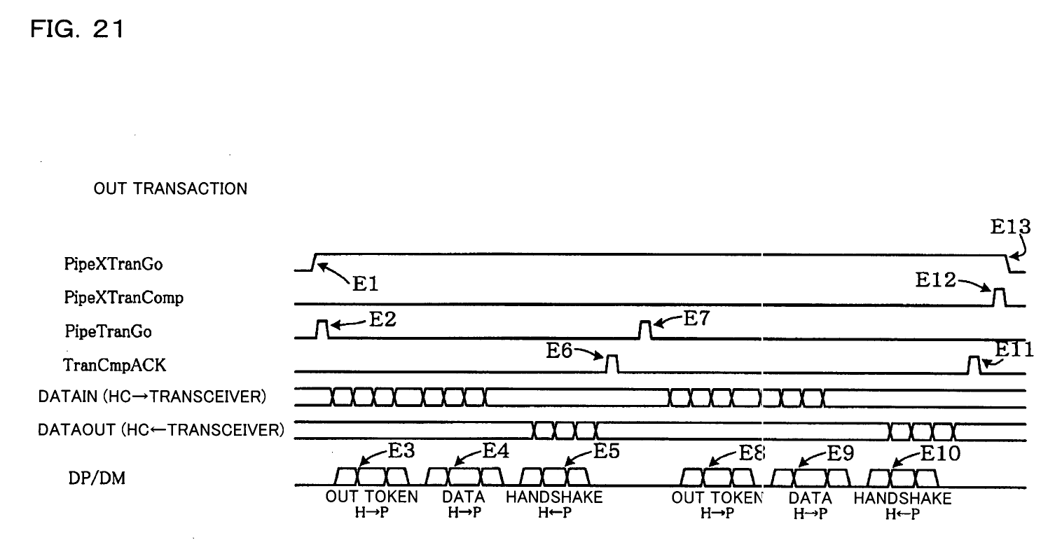

FIGS. 20 and 21 show examples of a signal waveform during automatic transaction processing by the host controller 50. In FIGS. 20 and 21, “H→P” indicates that the packet is transferred from the host to the peripheral, and “P→H” indicates that the packet is transferred from the peripheral to the host.

FIG. 20 is an example of a signal waveform in the case of IN transactions (transfer type is IN). When the firmware instructs start of automatic transactions in the step S4 shown in FIG. 19, PipeXTranGo (transfer request signal for PipeX from the firmware) is asserted as indicated by C1 shown in FIG. 20. This allows the host controller 50 to start automatic transaction processing for PipeX (X=0 to e).

When PipeTranGo (transfer request signal from an HC sequence management circuit in the host controller 50) is asserted as indicated by C2, the host controller 50 generates an IN token packet and transfers the packet to the peripheral through the USB as indicated by C3. When an IN data packet is transferred from the peripheral to the host controller 50 as indicated by C4, the host controller 50 generates a handshake packet (ACK) and transfers the handshake packet to the peripheral as indicated by C5. This causes TranCmpACK to be asserted as indicated by C6.

When PipeTranGo is asserted as indicated by C7, packet transfers indicated by C8, C9, and C10 are performed, whereby TranCmpACK is asserted as indicated by C11. This causes PipeXTranComp (transfer completion notification signal in a data unit of IRP to the firmware) to be asserted as indicated by C12. The firmware is notified of the completion of transfer for the pipe by the interrupt of PipeXTranComp.

When PipeXTranComp is asserted, PipeXTranGo is negated as indicated by C13, thereby indicating that the pipe is in a non-transfer state.

FIG. 21 is an example of a signal waveform in the case of OUT transactions (transfer type is OUT). When the firmware instructs to start automatic transactions, PipeXTranGo is asserted as indicated by E1 and PipeTranGo is asserted as indicated by E2. The host controller 50 transfers an OUT token packet to the peripheral as indicated by E3, and transfers an OUT data packet as indicated by E4. When the handshake packet (ACK) is returned from the peripheral as indicated by E5, TranCmpACK is asserted as indicated by E6.

When PipeTranGo is asserted as indicated by E7, packet transfers indicated by E8, E9, and E10 are performed, whereby TranCmpACK is asserted as indicated by E11 PipeXTranComp then is asserted as indicated by E12. The firmware is notified of the completion of transfer for the pipe by the interrupt of PipeXTranComp. When PipeXTranComp is asserted, PipeXTranGo is negated as indicated by E13.

8. Electronic Instrument

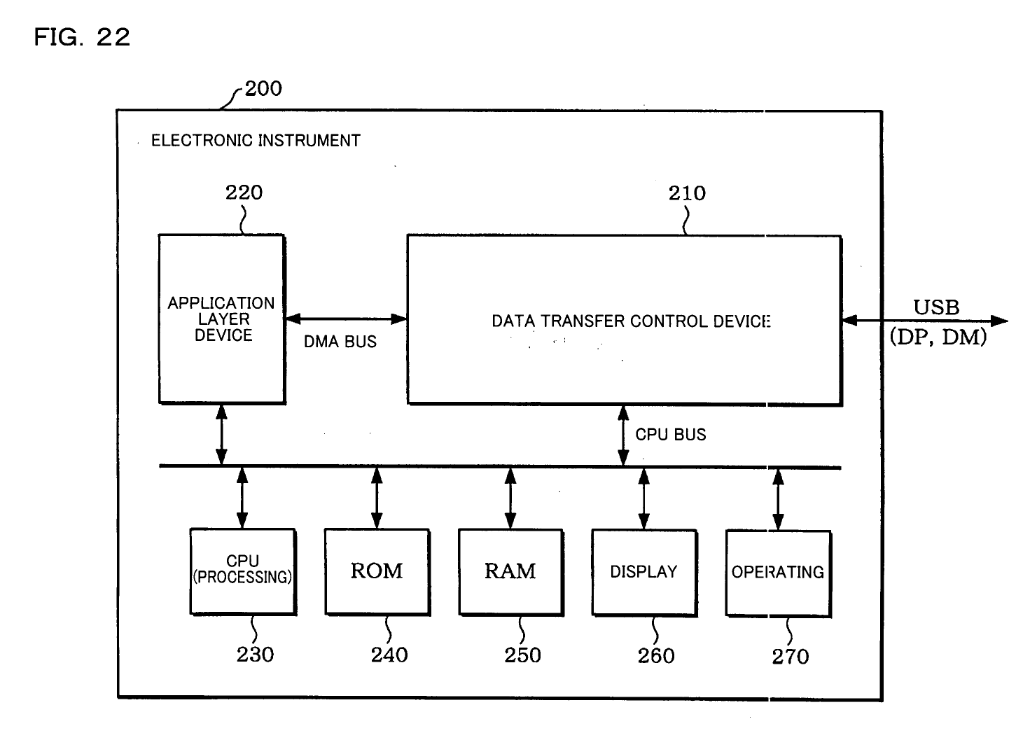

FIG. 22 shows a configuration example of an electronic instrument including the data transfer control device in the present embodiment. An electronic instrument 200 includes a data transfer control device 210 described in the present embodiment, an application layer device 220 formed by ASIC or the like, a CPU 230, a ROM 240, a RAM 250, a display section 260, and an operating section 270. The electronic instrument 200 may have a configuration in which some of these functional blocks are omitted.

The application layer device 220 is a device which controls a hard disk drive, an optical disk drive, or a printer, a device which includes an MPEG encoder and an MPEG decoder, or the like. The CPU 230 (processing section) controls the data transfer control device 210 and the entire electronic instrument. The ROM 240 stores a control program and various types of data. The RAM 250 functions as a work area and a data storage region for the CPU 230 and the data transfer control device 210. The display section 260 displays various types of information to the user. The operating section 270 allows the user to operate the electronic instrument.

In FIG. 22, a DMA bus and a CPU bus are separated. However, the DMA bus and the CPU bus may be a common bus. The CPU 230 may be included in the data transfer control device 210, or a CPU which controls the data transfer control device 210 and a CPU which controls the electronic instrument may be provided separately. As examples of electronic instruments to which the present embodiment can be applied, optical disk (CD-ROM and DVD) drives, magneto-optical (MO) disk drives, hard disk drives, TVs, TV tuners, VTRs, video cameras, audio devices, telephones, projectors, personal computers, electronic notebooks, PDAs, word processors, and the like can be given.

The present invention is not limited to the present embodiment. Various modifications and variations are possible within the spirit and scope of the present invention.

For example, the configuration of the data transfer control device in the present invention is not limited to the configuration described with reference to FIG. 2 and the like. Various modifications and variations are possible. For example, the present invention may be applied to a data transfer control device in which the configuration including the OTG controller 20, the HC/PC switch circuit 30, the peripheral controller 60, and the like shown in FIG. 2 is omitted and which does not have a peripheral function and has only a simple host function. The method of the present invention may be applied to reconstruction of the endpoint regions.

The terms (OTG controller, CPU and firmware, host controller and peripheral controller, USB, pipe region and endpoint region, maximum packet size, and the like) cited in the description in the specification and the drawings as the terms in a broad sense (state controller, processing section, transfer controller, bus, buffer region, page size, and the like) may be replaced by the terms in a broad sense in another description in the specification and the drawings.

Part of requirements of a claim of the present invention could be omitted from a dependent claim which depends on that claim. Moreover, part of requirements of any independent claim of the present invention could be made to depend on any other independent claim.

The present embodiment illustrates the application example for the USB OTG standard. However, application of the present invention is not limited to the OTG standard. For example, the present invention may be applied to data transfer in a standard based on the same idea as the OTG standard or a standard developed from the OTG standard.

The specification discloses the following matters about the configuration of the embodiments described above.

According to one embodiment of the present invention, there is provided a data transfer control device which includes a buffer controller which allocates a plurality of pipe regions in a packet buffer and controls access to the packet buffer, each of the pipe regions storing data transferred to or from corresponding one of endpoints, and a transfer controller which controls data transfer between each of the pipe regions and corresponding one of the endpoints, the data transfer control device comprising:
an address translation table which stores pipe region numbers each of which is assigned to at least one of divided blocks, the divided blocks being obtained by dividing a memory region of the packet buffer, and generates a physical access address of the packet buffer based on the stored pipe region numbers, a pipe region number to which access is requested, and a relative access address of the pipe regions; and
a region allocator which performs reconstruction processing of the pipe regions by changing the pipe region number assigned to the divided block of the packet buffer, the reconstruction processing including at least one of processing of deleting the allocated pipe region, processing of adding a new pipe region, and processing of changing a size of the pipe region.

According to this data transfer control device, the physical access address of the packet buffer is generated based on the pipe region numbers assigned to the divided blocks, one of the pipe region numbers to which access is requested, and the relative access address. This enables access to the packet buffer. In this data transfer control device, the reconstruction processing of the pipe regions is realized by changing the pipe region number assigned to one of the divided blocks of the packet buffer. The reconstruction processing includes processing of deleting an existing pipe region (buffer region), processing of adding a new pipe region, and processing of changing the size of an existing pipe region, and the like. This enables the reconstruction processing to be realized with a reduced load by changing the address translation table, whereby processing efficiency can be increased.

In the data transfer control device, the address translation table may include:
a plurality of block registers, each of the block registers storing the pipe region number assigned to the divided block;
comparators which compare the pipe region numbers stored in the block registers with the pipe region number to which access is requested; and
an address decoder which generates the physical access address based on comparison results of the comparators and the relative access address of the pipe regions.

In the data transfer control device, the region allocator may calculate a number of the divided blocks necessary for allocating each of the pipe regions based on a page size and a number of pages of each of the pipe regions, and may assign the pipe region number to each of the divided blocks based on the calculated number of the divided blocks.

With this configuration, the pipe region number can be assigned to each divided block by simply calculating the number of blocks in each divided block.

In the data transfer control device, the region allocator may read the pipe region numbers assigned to the divided blocks from the address translation table, and, on condition that clearance of the pipe region specified by the read pipe region number is permitted, may perform rewrite processing of the read pipe region number.

With this configuration, the rewrite processing of the pipe region number is performed for the pipe region, clearance of which is permitted (instructed). Thus, data stored in the pipe region, clearance of which is not permitted, is prevented from being lost.

In the data transfer control device, the region allocator may include a block number counter which counts divided block numbers, and a plurality of number-of-blocks counters, a number of the divided blocks necessary for allocating each of the pipe regions being set in each of the number-of-blocks counters as a counter value, may read the pipe region numbers assigned to the divided blocks from the address translation table based on the divided block numbers from the block number counter, and, each time the pipe region number is assigned to the divided block, may decrement a number of blocks set in the number-of-blocks counter corresponding to the assigned pipe region number.

The reconstruction processing can be completed by performing the assignment processing until the number of blocks set in all of the number-of-blocks counters becomes zero.

In the data transfer control device, the buffer controller may control access to the pipe region of the packet buffer based on a pointer which indicates the relative access address of the pipe region.

According to another embodiment of the present invention, there is provided a data transfer control device which includes a buffer controller which allocates a plurality of pipe regions in a packet buffer and controls access to the packet buffer, each of the pipe regions storing data transferred to or from corresponding one of endpoints, and a transfer controller which controls data transfer between each of the pipe regions and corresponding one of the endpoints, the data transfer control device comprising:
an address translation table which translates a logical access address of the packet buffer into a physical access address of the packet buffer; and
a region allocator which performs reconstruction processing of the pipe regions by changing correspondence between the logical access address and the physical access address in the address translation table, the reconstruction processing including at least one of processing of deleting the allocated pipe region, processing of adding a new pipe region, and processing of changing a size of the pipe region;
wherein the region allocator changes the correspondence between the logical access address and the physical access address for a first pipe region allocated in the packet buffer before and after the reconstruction processing corresponding to a first endpoint so that the physical access address does not change even when the logical access address of the first pipe region changes.

According to this data transfer control device, the reconstruction processing of the pipe regions is realized by changing the correspondence between the logical access address and the physical access address. Therefore, the reconstruction processing can be realized with a reduced load by changing the address translation table, whereby processing efficiency can be increased. Moreover, since the physical access address of the first pipe region allocated in the packet buffer before and after the reconstruction does not change even when the logical access address changes, data stored in the first pipe region can be prevented from being lost due to the reconstruction.

The data transfer control device may perform pause processing of pausing data transfer between the pipe regions and the endpoints
the data transfer control device may perform the reconstruction processing of the pipe regions after the pause processing of the data transfer has been completed, and
the data transfer control device may resume the data transfer which has been paused after the reconstruction processing of the pipe regions.

In this data transfer control device, when a pause instruction or the like is issued from the processing section, data transfer is temporarily paused in the middle of the data transfer. After the pause processing of data transfers for all of the pipe regions (there may be some exceptions) has been completed, for example, the reconstruction processing of the pipe regions is performed. Then, after the reconstruction processing is completed, the data transfer which has been paused is resumed, whereby the remaining data transfer is performed. This enables the pipe regions to be reconstructed without waiting for completion of the entire data transfer for the pipe regions, whereby processing efficiency can be increased.

The data transfer control device may further comprise:
a register which stores instruction information for the pause processing of the data transfer; and
a register which stores information which indicates that the pause processing has been completed for all of the pipe regions.

By providing such registers (instruction means and notification means), reconstruction of the pipe regions can be started after the pause processing is surely completed.

The data transfer control device may comprise:
a register section including a plurality of transfer condition registers, transfer condition information on data transfer between each of the pipe regions and corresponding one of the endpoints being set in each of the transfer condition registers,
wherein the transfer controller may automatically generate a transaction for each of the endpoints based on the transfer condition information set in each of the transfer condition registers, and may automatically transfer data between each of the pipe regions and corresponding one of the endpoints.

In this data transfer control device, the transfer condition information (endpoint information or pipe information) on data transfer between each pipe region and each endpoint is set in each transfer condition register (pipe register). A transaction for each endpoint is automatically generated based on the transfer condition information set in each transfer condition register, and data is automatically transferred between each pipe region and each endpoint. This reduces processing load of the processing section which controls the data transfer control device and the like.

The data transfer control device may comprise:
a state controller which controls a plurality of states including a state of a host operation in which the data transfer control device operates as a role of a host and a state of a peripheral operation in which the data transfer control device operates as a role of a peripheral,
wherein the transfer controller may include a host controller which transfers data as the host during the host operation and a peripheral controller which transfers data as the peripheral during the peripheral operation, and
wherein, during the host operation, the buffer controller may allocate the pipe regions in the packet buffer, and the host controller may transfer data between each of the allocated pipe regions and corresponding one of the endpoints.

According to this data transfer control device, when the state which is controlled by the state controller transitions to the state of the host operation, the host controller transfers data in the role of the host. When the state which is controlled by the state controller transitions to the state of the peripheral operation, the peripheral controller transfers data in the role of the peripheral. This realizes a function of a dual-role device. In this data transfer control device, a plurality of the pipe regions are allocated in the packet buffer during the host operation, and data is automatically transferred between the allocated pipe regions and the endpoints. This realizes a function of a dual-role device and reduces a processing load of the processing section during the host operation.

The data transfer control device may perform data transfer according to a Universal Serial Bus (USB) On-The-Go (OTG) standard.

According to a further embodiment of the present invention, there is provided an electronic instrument comprising:
one of the above described data transfer control devices;
a device which performs one of output processing, fetch processing, and storage processing of data transferred through the data transfer control device and a bus; and
a processing section which controls data transfer of the data transfer control device.

1. A data transfer control device which includes a buffer controller which allocates a plurality of pipe regions in a packet buffer and controls access to the packet buffer, each of the pipe regions storing data transferred to or from corresponding one of endpoints, and a transfer controller which controls data transfer between each of the pipe regions and corresponding one of the endpoints, the data transfer control device comprising:
an address translation table which stores pipe region numbers each of which is assigned to at least one of divided blocks, the divided blocks being obtained by dividing a memory region of the packet buffer, and generates a physical access address of the packet buffer based on the stored pipe region numbers, a pipe region number to which access is requested, and a relative access address of the pipe regions; and
a region allocator which performs reconstruction processing of the pipe regions by changing the pipe region number assigned to the divided block of the packet buffer, the reconstruction processing including at least one of processing of deleting the allocated pipe region, processing of adding a new pipe region, and processing of changing a size of the pipe region.

2. The data transfer control device as defined in claim 1,
wherein the address translation table includes:
a plurality of block registers, each of the block registers storing the pipe region number assigned to the divided block;
comparators which compare the pipe region numbers stored in the block registers with the pipe region number to which access is requested; and
an address decoder which generates the physical access address based on comparison results of the comparators and the relative access address of the pipe regions.

3. The data transfer control device as defined in claim 1,
wherein the region allocator calculates a number of the divided blocks necessary for allocating each of the pipe regions based on a page size and a number of pages of each of the pipe regions, and assigns the pipe region number to each of the divided blocks based on the calculated number of the divided blocks.

4. The data transfer control device as defined in claim 1,
wherein the region allocator reads the pipe region numbers assigned to the divided blocks from the address translation table, and, on condition that clearance of the pipe region specified by the read pipe region number is permitted, performs rewrite processing of the read pipe region number.

5. The data transfer control device as defined in claim 1,
wherein the region allocator:
includes a block number counter which counts divided block numbers, and a plurality of number-of-blocks counters, a number of the divided blocks necessary for allocating each of the pipe regions being set in each of the number-of-blocks counters as a counter value;
reads the pipe region numbers assigned to the divided blocks from the address translation table based on the divided block numbers from the block number counter; and,
each time the pipe region number is assigned to the divided block, decrements a number of blocks set in the number-of-blocks counter corresponding to the assigned pipe region number.

6. The data transfer control device as defined in claim 1,
wherein the buffer controller controls access to the pipe region of the packet buffer based on a pointer which indicates the relative access address of the pipe region.

7. A data transfer control device which includes a buffer controller which allocates a plurality of pipe regions in a packet buffer and controls access to the packet buffer, each of the pipe regions storing data transferred to or from corresponding one of endpoints, and a transfer controller which controls data transfer between each of the pipe regions and corresponding one of the endpoints, the data transfer control device comprising:
an address translation table which translates a logical access address of the packet buffer into a physical access address of the packet buffer; and
a region allocator which performs reconstruction processing of the pipe regions by changing correspondence between the logical access address and the physical access address in the address translation table, the reconstruction processing including at least one of processing of deleting the allocated pipe region, processing of adding a new pipe region, and processing of changing a size of the pipe region;
wherein the region allocator changes the correspondence between the logical access address and the physical access address for a first pipe region allocated in the packet buffer before and after the reconstruction processing corresponding to a first endpoint so that the physical access address does not change even when the logical access address of the first pipe region changes.

8. The data transfer control device as defined in claim 1,
wherein the data transfer control device performs pause processing of pausing data transfer between the pipe regions and the endpoints,
wherein the data transfer control device performs the reconstruction processing of the pipe regions after the pause processing of the data transfer has been completed, and
wherein the data transfer control device resumes the data transfer which has been paused after the reconstruction processing of the pipe regions.

9. The data transfer control device as defined in claim 7,
wherein the data transfer control device performs pause processing of pausing data transfer between the pipe regions and the endpoints,
wherein the data transfer control device performs the reconstruction processing of the pipe regions after the pause processing of the data transfer has been completed, and
wherein the data transfer control device resumes the data transfer which has been paused after the reconstruction processing of the pipe regions.

10. The data transfer control device as defined in claim 8, comprising:
a register which stores instruction information for the pause processing of the data transfer; and
a register which stores information which indicates that the pause processing has been completed for all of the pipe regions.

11. The data transfer control device as defined in claim 9, comprising:
a register which stores instruction information for the pause processing of the data transfer; and
a register which stores information which indicates that the pause processing has been completed for all of the pipe regions.

12. The data transfer control device as defined in claim 1, comprising:
a register section including a plurality of transfer condition registers, transfer condition information on data transfer between each of the pipe regions and corresponding one of the endpoints being set in each of the transfer condition registers,
wherein the transfer controller automatically generates a transaction for each of the endpoints based on the transfer condition information set in each of the transfer condition registers, and automatically transfers data between each of the pipe regions and corresponding one of the endpoints.

13. The data transfer control device as defined in claim 7, comprising:
a register section including a plurality of transfer condition registers, transfer condition information on data transfer between each of the pipe regions and corresponding one of the endpoints being set in each of the transfer condition registers,
wherein the transfer controller automatically generates a transaction for each of the endpoints based on the transfer condition information set in each of the transfer condition registers, and automatically transfers data between each of the pipe regions and corresponding one of the endpoints.

14. The data transfer control device as defined in claim 1, comprising:
a state controller which controls a plurality of states including a state of a host operation in which the data transfer control device operates as a role of a host and a state of a peripheral operation in which the data transfer control device operates as a role of a peripheral,
wherein the transfer controller includes a host controller which transfers data as the host during the host operation and a peripheral controller which transfers data as the peripheral during the peripheral operation, and
wherein, during the host operation, the buffer controller allocates the pipe regions in the packet buffer, and the host controller transfers data between each of the allocated pipe regions and corresponding one of the endpoints.

15. The data transfer control device as defined in claim 7, comprising:
a state controller which controls a plurality of states including a state of a host operation in which the data transfer control device operates as a role of a host and a state of a peripheral operation in which the data transfer control device operates as a role of a peripheral,
wherein the transfer controller includes a host controller which transfers data as the host during the host operation and a peripheral controller which transfers data as the peripheral during the peripheral operation, and
wherein, during the host operation, the buffer controller allocates the pipe regions in the packet buffer, and the host controller transfers data between each of the allocated pipe regions and corresponding one of the endpoints.

16. The data transfer control device as defined in claim 1, which performs data transfer according to a Universal Serial Bus (USB) On-The-Go (OTG) standard.

17. The data transfer control device as defined in claim 7, which performs data transfer according to a Universal Serial Bus (USB) On-The-Go (OTG) standard.

18. An electronic instrument comprising:
the data transfer control device as defined in claim 1;
a device which performs one of output processing, fetch processing, and storage processing of data transferred through the data transfer control device and a bus; and
a processing section which controls data transfer of the data transfer control device.

19. An electronic instrument comprising:
the data transfer control device as defined in claim 7;
a device which performs one of output processing, fetch processing, and storage processing of data transferred through the data transfer control device and a bus; and
a processing section which controls data transfer of the data transfer control device.

20. A data transfer control method for data transfer through a bus, the data transfer control method comprising:
allocating a plurality of pipe regions in a packet buffer, and controlling access to the packet buffer, each of the pipe regions storing data transferred to or from corresponding one of endpoints;
controlling data transfer between each of the pipe regions and corresponding one of the endpoints;
storing pipe region numbers each of which is assigned to at least one of divided blocks, the divided blocks being obtained by dividing a memory region of the packet buffer, and generating a physical access address of the packet buffer based on the stored pipe region numbers, a pipe region number to which access is requested, and a relative access address of the pipe regions; and
performing reconstruction processing of the pipe regions by changing the pipe region number assigned to the divided block of the packet buffer, the reconstruction processing including at least one of processing of deleting the allocated pipe region, processing of adding a new pipe region, and processing of changing a size of the pipe region.

21. A data transfer control method for data transfer through a bus, the data transfer control method comprising:
allocating a plurality of pipe regions in a packet buffer, and controlling access to the packet buffer, each of the pipe regions storing data transferred to or from corresponding one of endpoints;
controlling data transfer between each of the pipe regions and corresponding one of the endpoints;
translating a logical access address of the packet buffer into a physical access address of the packet buffer;
performing reconstruction processing of the pipe regions by changing correspondence between the logical access address and the physical access address in the address translation, the reconstruction processing including at least one of processing of deleting the allocated pipe region, processing of adding a new pipe region, and processing of changing a size of the pipe region; and
changing the correspondence between the logical access address and the physical access address for a first pipe region allocated in the packet buffer before and after the reconstruction processing corresponding to a first endpoint so that the physical access address does not change even when the logical access address of the first pipe region changes.
